(19) United States
(12) Patent Application Publication
(10) Pub. No.: US 2026/0213808 A1
(43) Pub. Date: Jul. 23, 2026

(54) CSI Reporting For Multiple CSI-RS Resources In a Wireless Communication System

(71) Applicant: Fraunhofer-Gesellschaft zur Förderung der angewandten Forschung e.V., MÜNCHEN (DE)

(72) Inventors: Marcus Grossmann, Erlangen (DE); Venkatesh Ramireddy, Erlangen (DE); Markus Landmann, Erlangen (DE)

(73) Assignee: Fraunhofer-Gesellschaft zur Förderung der angewandten Forschung e.V., MÜNCHEN (DE)

(21) Appl. No.: 19/141,014

(22) PCT Filed: Dec. 18, 2023
(86) PCT No.: PCT/EP2023/086452

§ 371 Date: Jun. 18, 2025

(30) Foreign Application Priority Data
Dec. 19, 2022 (EP) 22214774.6

(51) Int. Cl. H04B 7/06

(52) U.S. Cl. CPC H04B 7/0626; H04B 7/0639

(57) ABSTRACT

The present disclosure relates to methods and apparatuses, a wireless device (500) and a network node (600) for CSI feedback reporting. A method performed by the wireless device (500) comprises: receiving a CSI report configuration; determining a set of linear combining coefficients of a precoder matrix for a number of CSI-RS, resources; determining a bitmap for indicating a plurality of non-zero combining coefficients; assigning an ordering to the bits of the bitmap and assigning the same ordering to the plurality of non-zero combining coefficients, to be reported together with the bitmap, to the network node in a CSI report, dividing the plurality of non-zero combining coefficients into two or more CSI groups having associated priority levels; generating a CSI report comprising an indication of the spatial-domain and frequency-domain components and the determined bitmap, in addition to the non-zero combining coefficients, wherein the CSI report comprises a CSI part 1 and a CSI part 2, wherein CSI part 1 has a fixed payload size and comprises information indicating the size of the payload of CSI part 2, and wherein CSI part 2 includes the non-zero combining coefficients of at least one of the two or more CSI groups; and transmitting or reporting an uplink control information (UCI) including the CSI report over an uplink, UL, channel to the network node (600).

### TECHNICAL FIELD

The present disclosure relates to the field of wireless communications, and in particular to methods and apparatuses for Channel State Information (CSI) feedback reporting in an Uplink Control Channel (UCI) for a codebook based precoding for distributed Multiple-Input-Multiple-Output (MIMO) cooperative transmission in a wireless communications network such as advanced 5G networks.

### BACKGROUND

The fifth generation (5G) mobile communications system also known as new radio (NR) provides a higher level of performance than the previous generations of mobile communications system. 5G mobile communications has been driven by the need to provide ubiquitous connectivity for applications as diverse automotive communication, remote control with feedback, video downloads, as well as data applications for Internet-of-Things (IoT) devices, machine type communication (MTC) devices, etc. 5G wireless technology brings several main benefits, such as faster speed, shorter delays and increased connectivity. The third-generation partnership project (3GPP) provides the complete system specification for the 5G network architecture, which includes at least a radio access network (RAN), core transport networks (CN) and service capabilities.

FIG. 1 illustrates a simplified schematic view of an example of a wireless communications network 100 including a core network (CN) 110 and a radio access network (RAN) 120. The RAN 120 is shown including a plurality of network nodes or radio base stations, which in 5G are called gNBs. Three radio base stations are depicted gNB1, gNB2 and gNB3. Each gNB serves an area called a coverage area or a cell. FIG. 1 illustrates 3 cells 121, 122 and 123, each served by its own gNB, gNB1, gNB2 and gNB3, respectively. It should be mentioned that the network 100 may include any number of cells and gNBs. The radio base stations, or network nodes serve users within a cell. In 4G or LTE, a radio base station is called an eNB, in 3G or UMTS, a radio base station is called an eNodeB, and BS in other radio access technologies. A user or a user equipment (UE) may be a wireless or a mobile terminal device or a stationary communication device. A mobile terminal device or a UE may also be an IoT device, an MTC device, etc. IoT devices may include wireless sensors, software, actuators, and computer devices. They can be imbedded into mobile devices, motor vehicle, industrial equipment, environmental sensors, medical devices, aerial vehicles and more, as well as network connectivity that enables these devices to collect and exchange data across an existing network infrastructure.

Referring back to FIG. 1, each cell is shown including UEs and IoT devices. gNB1 in cell 121 serves UE1 121A, UE2 121B and IoT device 121C. Similarly, gNB2 in cell 121 serves UE3 122A, UE4 122B and IoT device 122C, and gNB3 in cell 123 serves UE5 123A, UE6 123B and IoT device 123C. The network 100 may include any number of UEs and IoT devices or any other types of devices. The devices communicate with the serving gNB(s) in the uplink and the gNB(s) communicate with the devices in the downlink. The respective base station gNB1 to gNB3 may be connected to the CN 120, e.g., via the S1 interface, via respective backhaul links 111, 121D, 122D, 123D, which are schematically depicted in FIG. 1 by the arrows pointing to “core”. The core network 120 may be connected to one or more external networks, such as the Internet. The gNBs may be connected to each other via the S1 interface or the X2 interface or the XN interface in 5G, via respective interface links 121E, 122E and 123E, which is depicted in the figure by the arrows pointing to gNBs.

For data transmission, a physical resource grid may be used. The physical resource grid may comprise a set of resource elements (REs) to which various physical channels and physical signals are mapped. For example, the physical channels may include the physical downlink, uplink and/or sidelink (SL) shared channels (PDSCH, PUSCH, PSSCH) carrying user specific data, also referred to as downlink, uplink or sidelink payload data, the physical broadcast channel (PBCH) carrying for example a master information block (MIB) and a system information block (SIB), the physical downlink, uplink and/or sidelink control channels (PDCCH, PUCCH, PSCCH) carrying for example the downlink control information (DCI), the uplink control information (UCI) or the sidelink control information (SCI). For the uplink, the physical channels may further include the physical random-access channel (PRACH or RACH) used by UEs for accessing the network once a UE is synchronized and obtains the MIB and SIB. The physical signals may comprise reference signals (RS), synchronization signals (SSs) and the like. The resource grid may comprise a frame or radio frame having a certain duration, like 10 milliseconds, in the time domain and having a given bandwidth in the frequency domain. The radio frame may have a certain number of subframes of a predefined length, e.g., 2 subframes with a length of 1 millisecond. Each subframe may include two slots of a number of OFDM symbols depending on the cyclic prefix (CP) length. IN 5G, each slot consists of 14 OFDM symbols or 12 OFDM symbols based on normal CP and extended CP respectively. A frame may also consist of a smaller number of OFDM symbols, e.g., when utilizing shortened transmission time intervals (TTIs) or a mini-slot/non-slot-based frame structure comprising just a few OFDM symbols. Slot aggregation is supported in 5G NR and hence data transmission can be scheduled to span one or multiple slots. Slot format indication informs a UE whether an OFDM symbol is downlink, uplink or flexible.

The wireless communication network system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g., DFT-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the 5G or NR (New Radio) standard.

The wireless communications network system depicted in FIG. 1 may be a heterogeneous network having two distinct overlaid networks, a network of macro cells with each macro cell including a macro base station, like base station gNB1 to gNB3, and a network of small cell base stations (not shown in FIG. 1), like femto- or pico-base stations. In addition to the above described wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-advanced pro standard or the 5G or NR, standard.

In the wireless communications network system such as the one depicted schematically in FIG. 1, multi-antenna techniques may be used, e.g., in accordance with LTE, NR or any other communication system, to improve user data rates, link reliability, cell coverage and network capacity. To support multi-stream or multi-layer transmissions, linear precoding is used in the physical layer of the communication system. Linear precoding is performed by a precoder matrix which maps layers of data to antenna ports. The precoding may be seen as a generalization of beamforming, which is a technique to spatially direct or focus a data transmission towards an intended receiver. The precoder matrix to be used at the gNB to map the data to the transmit antenna ports is decided using channel state information, CSI.

In the wireless communications network system as described above, such as LTE or New Radio (5G), downlink signals convey data signals, control signals containing downlink, DL, control information (DCI), and a number of reference signals or symbols (RS) used for different purposes. A gNodeB (or gNB or base station) transmits data and downlink control information (DCI) through the so-called physical downlink shared channel (PDSCH) and physical downlink control channel (PDCCH) or enhanced PDCCH (ePDCCH), respectively. Moreover, the downlink signal(s) of the gNB may contain one or multiple types of reference signals (RSs) including a common RS (CRS) in LTE, a channel state information RS (CSI-RS), a demodulation RS (DM-RS), and a phase tracking RS (PT-RS). The CRS is transmitted over a DL system bandwidth part and used at the user equipment (UE) to obtain a channel estimate to demodulate the data or control information. The CSI-RS is transmitted with a reduced density in the time and frequency domain compared to CRS and used at the UE for channel estimation or for channel state information (CSI) acquisition. The DM-RS is transmitted only in a bandwidth part of the respective PDSCH and used by the UE for data demodulation. For signal precoding at the gNB, several CSI-RS reporting mechanisms are used such as non-precoded CSI-RS and beamformed CSI-RS reporting. For a non-precoded CSI-RS, a one-to-one mapping between a CSI-RS port and a transceiver unit, TXRU, of the antenna array at the gNB is utilized. Therefore, non-precoded CSI-RS provides a cell-wide coverage where the different CSI-RS ports have the same beam direction and beam width. For beamformed/precoded UE-specific or non-UE-specific CSI-RS, a beamforming operation is applied over a single antenna port or over multiple antenna ports to have several narrow beams with high gain in different directions and, therefore, no cell-wide coverage.

In a wireless communications network system employing time division duplexing, TDD, due to channel reciprocity, the CSI is available at the base station (gNB). However, when employing frequency division duplexing, FDD, due to the absence of channel reciprocity, the channel is estimated at the UE and the estimate is fed back to the gNB. FIG. 2 shows a block-based model of a Multiple Input Multiple Output (MIMO) DL transmission using codebook-based-precoding in accordance with LTE release 8. FIG. 2 shows schematically the base station 200, gNB, the user equipment, UE, 202 and the channel 204, like a radio channel for a wireless data communication between the base station 200 and the user equipment 202. The base station includes an antenna array ANT_{T} having a plurality of antennas or antenna elements, and a precoder 206 receiving a data vector 208 and a precoder matrix F from a codebook 210. The channel 204 may be described by the channel tensor/matrix 212. The user equipment 202 receives the data vector 214 via an antenna or an antenna array ANT_{R} having a plurality of antennas or antenna elements. A feedback channel 216 between the user equipment 202 and the base station 200 is provided for transmitting feedback information. The previous releases of 3GPP up to Release 15 support the use of several downlink reference symbols (such as CSI-RS) for CSI estimation at the UE.

In FDD systems (up to Rel. 15), the estimated channel at the UE is reported to the gNB implicitly where the CSI report transmitted by the UE over the feedback channel includes the rank index (RI), the precoding matrix index (PMI) and the channel quality index (CQI) (and the CRI from Rel. 13) allowing, at the gNB, to decide the precoding matrix, and the modulation order and coding scheme (MCS) of the symbols to be transmitted. The PMI and the RI are used to determine the precoding matrix from a predefined set of matrices 22 also referred to as codebook. The codebook, e.g., in accordance with LTE, may be a look-up table with matrices in each entry of the table, and the PMI and RI from the UE decide from which row and column of the table the precoder matrix to be used is obtained. The precoders and codebooks are designed up to Rel. 15 for gNBs equipped with one-dimensional Uniform Linear Arrays (ULAs) having N₁ dual-polarized antennas (in total Nₜ=2N₁ antennas), or with two-dimensional Uniform Planar Arrays (UPAs) having dual-polarized antennas at N₁N₂ positions (in total Nₜ=2N₁N₂ antennas). The ULA allows controlling the radio wave in the horizontal (azimuth) direction only, so that azimuth-only beamforming at the gNB is possible, whereas the UPA supports transmit beamforming on both vertical (elevation) and horizontal (azimuth) directions, which is also referred to as full-dimension (FD) MIMO. The codebook, e.g., in the case of massive antenna arrays such as FD-MIMO, may be a set of beamforming weights that forms spatially separated electromagnetic transmit/receive beams using the array response vectors of the array. The beamforming weights (also referred to as the array steering vectors) of the array are amplitude gains and phase adjustments that are applied to the signal fed to the antennas (or the signal received from the antennas) to transmit (or obtain) a radiation towards (or from) a particular direction. The components of the precoder matrix are obtained from the codebook, and the PMI and the RI are used to read the codebook and obtain the precoder. The array steering vectors may be described by the columns of a 2 Dimensional Discrete Fourier Transform (DFT) matrix when ULAs or UPAs are used for signal transmission.

The precoder matrices used in the Type-I, Type-I multi-panel and Type-II CSI reporting schemes in 3GPP New Radio Rel. 15 are defined in the frequency-domain and have a dual-stage structure (i.e., two components codebook): F(s)=F₁F₂(s), s=0 . . . , S−1, where S denotes the number of subbands. The first component or the so-called first stage precoder, F₁, is used to select a number of beam vectors from a Discrete Fourier Transform-based (DFT-based) matrix, which is also called the spatial codebook. Moreover, the first stage precoder, F₁, corresponds to a wide-band matrix, independent of the subband index s, and contains L spatial beamforming vectors (the so-called spatial beams) bₗ∈ [symbol] ^{N}^{₁}^{N}^{₂}^{×1}, l=0, . . . , L−1 selected from a DFT-based codebook matrix for the two polarizations of the antenna array,

$${F}_{1} = [ \begin{matrix}{b}_{0} , … , {b}_{L - 1} & 0 … 0 \\ 0 … 0 & {b}_{0} , … , {b}_{L - 1}\end{matrix} ] .$$

For the type-I codebook, L=1 such that F₁ is simply given by

$${F}_{1} = [ \begin{matrix}{b}_{0} & 0 \\ 0 & {b}_{0}\end{matrix} ] .$$

The spatial codebook comprises an oversampled DFT matrix of dimension N₁N₂×N₁O₁N₂O₂, where O₁ and O₂ denote the oversampling factors with respect to the first and second dimension of the codebook, respectively. The DFT vectors in the codebook are grouped into (q₁, q₂), 0≤q₁≤O₁−1, 0≤q₂≤O₂−1 subgroups, where each subgroup contains N₁N₂ DFT-based vectors, and the parameters q₁ and q₂ are denoted as the rotation oversampling factors, with respect to the first and second dimension of the antenna array, respectively.

The second component or the so-called second stage precoder, F₂(s), is used to combine the selected beam vectors. This means the second stage precoder, F₂(s), corresponds to a selection/combining/co-phasing matrix to select/combine/co-phase the beams defined in F₁ for the s-th configured sub-band. For example, for a rank-1 transmission and Type-I CSI reporting, F₂(s) is given for a dual-polarized antenna array by

$${F}_{2} ( s ) = [ \begin{matrix}1 \\ {e}^{j {δ}_{1}}\end{matrix} ] , {e}^{j {δ}_{1}}$$

is a quantized co-phasing factor (phase adjustment) between the two orthogonal polarizations of the antenna array. Hence, for the Type-I codebook, a single DFT-beam is selected per transmission layer of the precoding such that the transmission is directed for the strongest path component of the radio channel.

For a rank-1 transmission and Type-II CSI reporting, F₂(s) is given for dual-polarized antenna arrays by

$${F}_{2} ( s ) = [ \begin{matrix}{e}^{j {δ}_{0}} {p}_{0} \\ ⋮ \\ {e}^{j {δ}_{2 L - 1}} {p}_{2 L - 1}\end{matrix} ] ,$$

where pₗ and e^{jδ}^{ₗ}, l=0, 2, . . . , 2L−1 are quantized amplitude and phase beam-combining coefficients, respectively. For rank-R transmission, F₂(s) contains R vectors, wherein R denotes the transmission rank, where the entries of each vector are chosen to combine single or multiple beams within each polarization.

The selection of the matrices F₁ and F₂(s) is performed by the UE based on reference signals such as CSI-RS and the knowledge of the channel conditions. The selected matrices are indicated in a CSI report in the form of a RI (the RI denotes the rank of the precoding matrices) and a PMI and are used at the gNB to update the multi-user precoder for the next transmission time interval.

In addition to the Type-I codebook, the Rel. 15 3GPP specification also defines a Type-I multi-panel (multi-antenna array) codebook for the case the gNB is equipped with multiple (co-located) antenna panels or antenna arrays that are possibly un-calibrated. The precoder for this codebook is similar to the Type-I codebook where a single DFT beam is applied per transmission layer of the precoding matrix. To take into account different spacing between the antenna panels and/or possible phase calibrations errors (e.g., due to different local oscillators) between the antenna panels, a per-panel co-phasing factor is applied to each panel. For example, for a rank-1 transmission and a gNB that is equipped with N_{g}=2 antenna panels, the Type-I multi-panel CSI reporting is defined as

$$F ( s ) = [ \begin{matrix}{b}_{0} \\ {e}^{j {δ}_{1}} {b}_{0} \\ {e}^{j {δ}_{2}} {b}_{0} \\ {e}^{j {δ}_{1}} {e}^{j {δ}_{2}} {b}_{0}\end{matrix} ] ,$$

where e^{jδ}^{₁} and e^{jδ}^{₂} are quantized co-phasing factors with e^{jδ}^{₂} being a panel-specific co-phasing factor applied to the second panel.

The current 3GPP NR Type-I and Type-II codebooks are designed for deployments where a gNB is equipped with a single panel or antenna array or multiple co-located panels or antenna arrays. The current 3GPP specification, however, does not support CSI reporting for so-called “distributed MIMO cooperative transmissions” where several panels or antenna arrays connected to a gNB operate as a large distributed multi-panel or multi-antenna array. Therefore, there is a need for new codebooks and CSI reporting schemes that can be used in distributed MIMO deployments. This invention according to this disclosure proposes extensions to the NR Type-II codebook and CSI reporting for distributed MIMO cooperative transmission.

### UCI Omission for CSI Reporting

UCI or CSI omission for PUSCH-based resource allocation and CSI reporting was introduced in 3GPP Rel-15. It allows a wireless device or UE to drop some parts of one or more CSI report(s) in the case that the PUSCH resource allocation is not sufficient to carry the entire content of the CSI report(s). UCI omission may happen when the base station did not accurately allocate the PUSCH resources when scheduling the CSI report(s). For example, the base station may allocate resources for a rank-1 (RI=1) CSI report, but the UE determines a rank-2 transmission and reports a rank-2 (RI=2) CSI report of which size is larger than the size of the allocated PUSCH resources. In such a case, the UE has to drop a portion of the UCI content. In 3GPP Rel. 15 and Rel. 16 the dropping is achieved by decomposing the UCI payload associated with the CSI reports into smaller portions, the so-called priority levels, where priority level 0 has the highest priority, and represents the total number of CSI reports configured to be carried on the PUSCH. Each priority level is associated with a part of a CSI report. The UE drops the CSI portions with lower priority such that the payload size of the CSI reports fits with the PUSCH resource allocation. The CSI report is decomposed into a number of CSI portions. Here, a CSI portion, or the so-called subband PMI in Rel. 15, contains the CSI content(s) associated with the even or odd subbands of the CSI report. Moreover, each subband PMI is associated with a priority level. The motivation behind the Rel. 15 subband-based CSI decomposition and omission method is that in case of omission of a first subband PMI of CSI report n, the base station may use the CSI content of the reported second subband PMI of CSI report n to estimate the CSI of the omitted first subband PMI by using an interpolation scheme. In this way, a severe degradation of the performance can be avoided as neighbored subbands are typically highly correlated.

There are thus drawbacks with the known solutions as described above and the present invention according to the present disclosure addresses these drawbacks. Consequently, new enhanced CSI reporting, schemes and rules, for example CSI or UCI omission, for distributed MIMO cooperative transmission are required.

### SUMMARY

It is an objective of the embodiments herein to provide methods and apparatuses for CSI feedback reporting for a codebook based precoding in a wireless communications network such as advanced 5G networks.

According to an aspect of some embodiments herein, there is provided a method performed by a wireless device (or UE) generating and reporting or transmitting a CSI report the method comprising:
receiving a CSI report configuration from a network node;
determining based on the received CSI report configuration, a set of linear combining coefficients of a precoder matrix for a number of CSI-Reference Signal, CSI-RS, resources; wherein the set of linear combining coefficients comprises a plurality of non-zero combining coefficients, and wherein the CSI-RS resources are indicated in the CSI report configuration;
determining a bitmap for indicating, using bits or by means of bits, a plurality of non-zero combining coefficients from the set of linear combining coefficients, and assigning an ordering to the bits of the bitmap and assigning the same ordering to the plurality of non-zero combining coefficients, to be reported together with the bitmap, to the network node in a CSI report,
dividing the plurality of non-zero combining coefficients into two or more CSI groups having associated priority levels;
generating a CSI report comprising an indication of the spatial-domain and frequency-domain components and the determined bitmap, in addition to the non-zero combining coefficients, wherein the CSI report comprises a CSI part 1 and a CSI part 2, wherein CSI part 1 has a fixed payload size and comprises information indicating the size of the payload of CSI part 2, and wherein CSI part 2 includes the non-zero combining coefficients of at least one of the two or more CSI groups; and
transmitting or reporting an uplink control information (UCI) including the CSI report over an uplink, UL, channel to the network node.

According to another aspect of embodiments herein, there is provided a method performed by a network node, the method comprising:
transmitting, to the wireless device, a CSI report configuration; for enabling the wireless device to:
   determine based on the received CSI report configuration, a set of linear combining coefficients of a precoder matrix for a number of CSI-Reference Signal, CSI-RS, resources; wherein the set of linear combining coefficients comprises a plurality of non-zero combining coefficients, and wherein the CSI-RS resources are indicated in the CSI report configuration;
   determine a bitmap for indicating, using bits or by means of bits, a plurality of non-zero combining coefficients from the set of linear combining coefficients;
   assign an ordering to the bits of the bitmap and assigning the same ordering to the plurality of non-zero combining coefficients, to be reported together with the bitmap, to the network node in a CSI report,
   divide the plurality of non-zero combining coefficients into two or more CSI groups having associated priority levels;
   generate a CSI report, for transmission to the network node comprising an indication of the spatial-domain and frequency-domain components and the determined bitmap, in addition to the non-zero combining coefficients, wherein the CSI report comprises a CSI part 1 and a CSI part 2, wherein CSI part 1 has a fixed payload size and comprises information indicating the size of the payload of CSI part 2, and wherein CSI part 2 includes the non-zero combining coefficients of at least one of the two or more CSI groups; and
receiving, from the wireless device and uplink control information (UCI) including the CSI report over an uplink, UL, channel.

According to another aspect of embodiments herein, there is also provided a wireless device or UE comprising a processor and a memory containing instructions executable by the processor, whereby said UE is operative or configured to perform any one of the embodiments presented in the detailed description related to the actions performed by the UE, such as in method claim 1.

According to yet another aspect of embodiments herein, there is also provided a network node comprising a processor and a memory containing instructions executable by the processor, whereby said network node is operative or configured to perform any one of the embodiments presented in the detailed description related to the network node, such as in at least method claim 2.

There is also provided a computer program comprising instructions which when executed on at least one processor of the UE, cause the at least said one processor to carry out the actions or method steps presented herein.

There is also provided a computer program comprising instructions which when executed on at least one processor of the network node, cause the at least said one processor to carry out the method steps presented herein.

A carrier is also provided containing the computer program, wherein the carrier is one of a computer readable storage medium, an electronic signal, optical signal, or a radio signal.

An advantage of the embodiments herein is to significantly reduce the feedback overhead and the computational complexity at the UE for codebook-based CSI reporting for joint transmission from a network node or gNB equipped with multiple RRHs or panels or antenna arrays to the UE. Another advantage is to reduce latency of the CSI reporting.

Additional advantages of the embodiments herein are provided in the detailed description of this disclosure.

### BRIEF DESCRIPTION OF THE DRAWINGS

Embodiments of the present invention are now described in further detail with reference to the accompanying drawings, in which:

FIG. 1 shows a schematic representation of a wireless communications system;

FIG. 2 shows a block-based model of a MIMO DL transmission using codebook-based-precoding in accordance with LTE Release 8;

FIG. 3 is a schematic representation of a wireless communications system for communicating information between a transmitter and a plurality of receivers, wherein embodiments herein may be employed;

FIG. 4 illustrates a flowchart of a method performed by a wireless device (or UE) according to some embodiments herein;

FIG. 5 illustrates a flowchart of a method performed by a network node according to some embodiments herein;

FIG. 6 is a block diagram depicting a wireless device according to some embodiments herein;

FIG. 7 is a block diagram depicting a network node according to some embodiments herein.

### DETAILED DESCRIPTION

In the following, a detailed description of the exemplary embodiments is described in conjunction with the drawings, in several scenarios to enable easier understanding of the solution(s) described herein.

For the 3GPP Rel.-15 dual-stage Type-II CSI reporting, the second stage precoder, F₂(s), is calculated on a subband basis such that the number of columns of

$${F}_{2} = [ {F}_{2}^{( r )} ( 0 ) … {F}_{2}^{( r )} ( s ) … {F}_{2}^{( r )} ( S - 1 ) ]$$

for the r-th transmission layer depends on the number of configured CQI subbands S. Here, a subband refers to a group of adjacent physical resource blocks (PRBs). A drawback of the Type-II CSI feedback is the large feedback overhead for reporting the combining coefficients on a subband basis. The feedback overhead increases approximately linearly with the number of subbands and becomes considerably large for large numbers of subbands. To overcome the high feedback overhead of the Rel.-15 Type-II CSI reporting scheme, it has been decided in 3GPP RAN #81 to study feedback compression schemes for the second stage precoder F₂. In several contributions, it has been demonstrated that the number of beam-combining coefficients in F₂ may be drastically reduced when transforming F₂ using a small set of DFT-based basis vectors into the transform domain referred to as the delay domain. The corresponding three-stage precoder relies on a three-stage (i.e., three components)

$${F}_{1} {F}_{2}^{( r )} {F}_{3}^{( r )}$$

codebook. The first component, represented by the matrix F₁, is identical to the Rel.-15 NR component, is independent of the transmission layer (r), and contains a number of spatial domain (SD) basis vectors selected from the spatial codebook. The second component, represented by the matrix

$${F}_{3}^{( r )} ,$$

is layer-dependent and is used to select a number of delay domain (DD) basis vectors from a Discrete Fourier Transform-based (DFT-based) matrix which is also called the delay codebook. The third component, represented by the matrix

$${F}_{2}^{( r )} ,$$

contains a number of combining coefficients that are used to combine the selected SD basis vectors and DD basis vectors from the spatial and delay codebooks, respectively.

Assuming a rank-R transmission the three-component precoder matrix or CSI matrix for a configured 2N₁N₂ antenna/CSI-RS ports and configured S subbands is represented for a first polarization of the antenna ports and r-th transmission layer as

$${F}^{( r , 1 )} = {α}^{( r )} {\sum }_{l = 0}^{L - 1} {b}_{l} {\sum }_{d = 0}^{D - 1} {γ}_{1 , l , d}^{( r )} {d}_{d}^{( r )}$$

and for a second polarization of the antenna ports and r-th transmission layer as

$${F}^{( r , 2 )} = {α}^{( r )} {\sum }_{l = 0}^{L - 1} {b}_{l} {\sum }_{i ( = 0}^{D - 1} {γ}_{2 , l , d}^{( r )} {d}_{d}^{( r )} ,$$

where bᵤ (l=0, . . . , L−1) represents the u-th SD basis vector selected from the spatial codebook,

$${d}_{d}^{( r )} ( d = 0 , … , D - 1 )$$

is the d-th FD basis vector associated with the r-th layer selected from the delay codebook,

$${γ}_{p , l , d}^{( r )}$$

is the complex delay-domain combining coefficient associated with the u-th SD basis vector, the d-th FD basis vector and the p-th polarization, D represents the number of configured FD basis vectors, and α^{(r)} is a normalizing scalar.

An advantage of the three-component CSI reporting scheme in the above equations is that the feedback overhead for reporting the combining coefficient of the precoder matrix or CSI matrix is no longer dependent on the number of configured CQI subbands (i.e., it is independent from the system bandwidth). Therefore, the above three-component codebook has been recently adopted for the 3GPP Rel.-16 dual-stage Type-II CSI reporting specification.

As mentioned, the current 3GPP NR Type-I and Type-II codebooks support only deployments where a network node, e.g., a gNB, is equipped with a single panel or multiple co-located panels or antenna arrays. There is no support of a CSI reporting for distributed MIMO cooperative transmissions where several panels or antenna arrays are connected to a network node, e.g., a gNB, that operate as a large distributed multi-panel or multi-antenna array.

Therefore, in this invention new codebooks and CSI reporting schemes for distributed MIMO deployments are proposed. The invention according to the present embodiment addresses the previously described drawbacks. In detail, methods that significantly reduce the feedback overhead and the computational complexity at the user equipment for codebook-based CSI reporting for distributed MIMO deployments are proposed.

### Precoder Structure and CSI Reporting

It should be noted that the term “precoding” equally means “precoder”. Hence, throughout this disclosure precoding and precoder are used interchangeably.

The term ‘beam’ is used to denote a spatially selective/directive transmission of an outgoing signal or reception of an incoming signal which is achieved by precoding/filtering the signal at the antenna ports of the device (UE or gNB) with a particular set of coefficients. The words precoding or precoder or filtering may refer to processing of the signal in the analog domain or in the digital domain. The set of coefficients used to spatially direct a transmission/reception in a certain direction may differ from one direction to another direction. The term ‘Tx beam’ denotes a spatially selective/directive transmission and the term ‘Rx beam’ denotes a spatially selective/directive reception. The set of coefficients used to precode/filter the transmission or reception is denoted by the term ‘spatial filter’. The term ‘spatial filter’ is used interchangeably with the term ‘beam direction’ in this document as the spatial filter coefficients determine the direction in which a transmission/reception is spatially directed to.

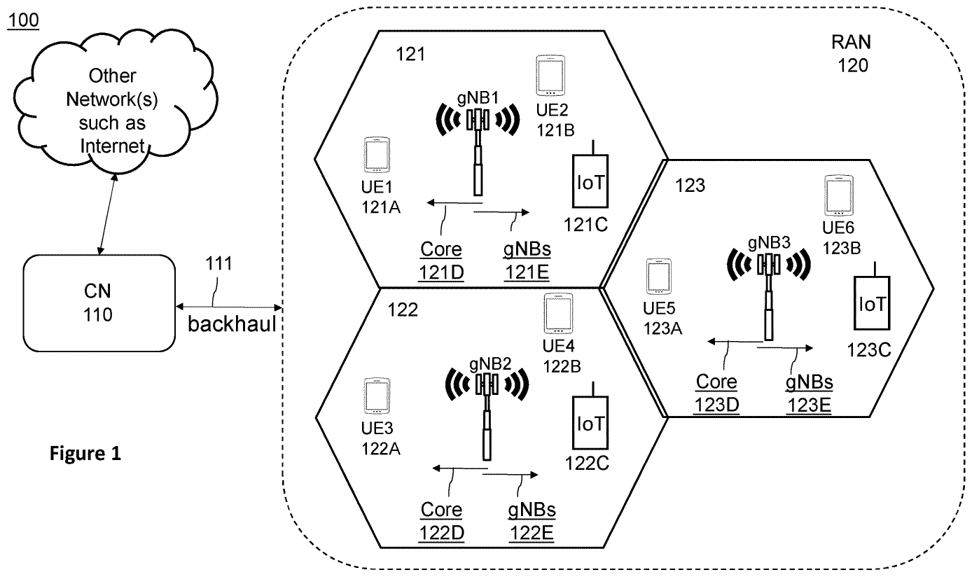

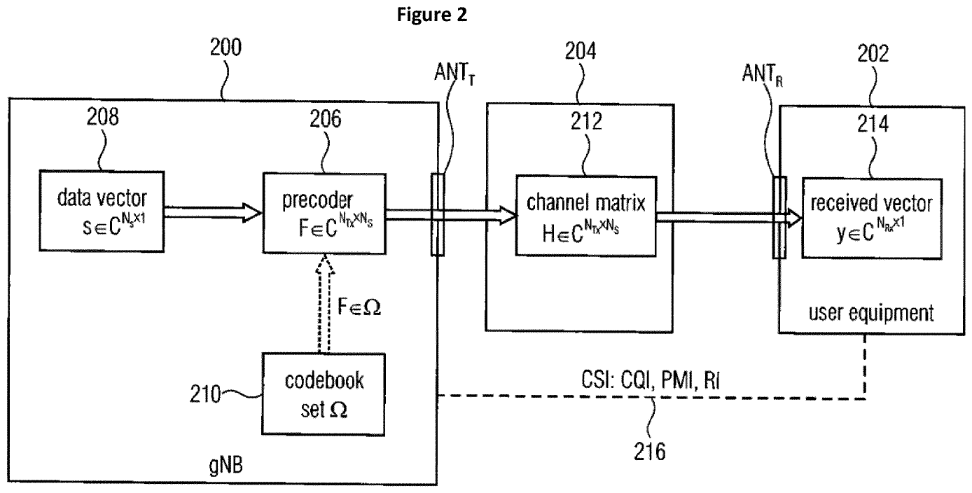

Exemplary embodiments of the present invention may be implemented in a wireless communications system or network as depicted in FIG. 1 or FIG. 2 including transmitters or transceivers, like base stations, and communication devices (receivers) or users, like mobile or stationary terminals or IoT devices or UEs, as mentioned earlier in the background part of this disclosure.

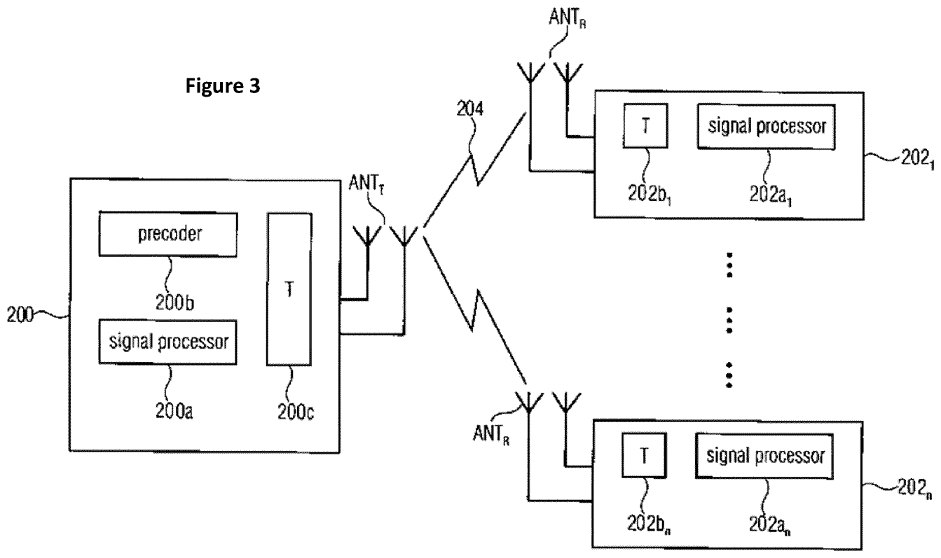

Referring to FIG. 3, there is depicted a schematic representation of a wireless communications system for communicating information between a transmitter 200, like a base station or a gNB, and a plurality of wireless devices 202₁ to 202ₙ, like UEs, which are served by the network node, like a base station 200. The network nodes 200 and the UEs 202 may communicate via a wireless communication link or channel 204, like a radio link. The network node 200 includes one or more antennas ANT_{T} or an antenna array having a plurality of antenna elements, and a signal processor 200a. The UEs 202 include one or more antennas ANT_{R} or an antenna array having a plurality of antennas, a signal processor 202a₁, 202aₙ, and a transceiver 202b₁, 202bₙ. The base station 200 and the respective UEs 202 may operate in accordance with the inventive teachings described herein.

According to embodiments herein, the wireless device is configured to generate a CSI report about a radio channel between the wireless device and a network node, e.g., a gNB in a wireless communications system. The radio channel may be a MIMO channel.

The wireless device mentioned above may include one or more of the following: a UE, or a mobile terminal, or a stationary terminal, or a cellular IoT-UE, or a vehicular UE, or a vehicular group leader (GL) UE, or an IoT, or a narrowband IoT, NB-IoT, device, or a WiFi non Access Point STAtion, non-AP STA, e.g., 802.11ax or 802.11be, or a ground based vehicle, or an aerial vehicle, or a drone, or a moving base station, or a road side unit, or a building, or any other item or device provided with network connectivity enabling the item/device to communicate using the wireless communication network, e.g., a sensor or actuator, or a macro cell base station, or a small cell base station, or a central unit of a base station, or a distributed unit of a base station, or a relay, or a remote radio head, or an AMF, or an SMF, or a core network entity, or mobile edge computing entity, or a network slice as in the NR or 5G core context, or any transmission/reception point, TRP, enabling an item or a device to communicate using the wireless communication network, the item or device being provided with network connectivity to communicate using the wireless communication network. A receiver may be a network node or gNB or a base station. Vice versa, a transmitter may be viewed as a radio base station or a network node or gNB, whereas a receiver may be a UE.

In general, and in accordance with some non-limiting exemplary effects achieved by the embodiments herein include a UE receiving from a network node or gNB a CSI report configuration indicating one or more CSI-RS resources. Each CSI-RS resource comprises a number of CSI-RS ports and is associated with a panel or remote radio head or antenna array of the network node or gNB. In some examples, the CSI report configuration comprises at least the parameters P_{CSI-RS}, or N₁, and N₂, whereas the value of P_{CSI-RS} indicates the number of CSI-RS or antenna ports of a CSI-RS resource for a polarization of a panel or antenna array of a remote radio head (RRH), and N₁, and N₂ denote the number of antenna ports for a first dimension and a second dimension of a polarization of a panel or antenna array of an RRH, respectively.

### Precoder Description

In a certain embodiment, the wireless device determines a precoder or precoder vector or matrix for RI transmission layers and indicates the precoder or precoder vector or matrix in the CSI report. Each precoder vector or matrix of the plurality of precoder vectors or matrices is represented by a linear combination of spatial-domain components and frequency-domain components, and a set of combining/combination coefficients for combining the spatial-domain components and frequency-domain components as described herein. The plurality of precoder vectors or matrices may be indicated in the CSI report by indicating the spatial-domain components and frequency-domain and the set of linear combination coefficients.

The term ‘combination coefficient’ and the term ‘combining coefficient’ in this disclosure can be used interchangeably.

The precoder vectors or matrices may be defined over a number of subbands, N₃. The bandwidth of the DL channel may be divided into a number of subbands, wherein each precoder vector or matrix is associated with a sub-band. In certain embodiments, the number of subbands of the precoder is an integer number (or a real number smaller than 1) of the number of CQI subbands configured to the wireless device. The number of CQI subbands may be indicated to the wireless device via the CSI report configuration.

The precoder vectors or matrices are determined by the wireless device based on measurements of the received reference signals (e.g., CSI-RS), wherein the reference signals are provided by another wireless device or the network node. The reference signals are configured to the wireless device via the CSI report configuration. The wireless device is configured to perform CSI measurements on one or more configured CSI-RS resources and to determine based on the CSI measurements the precoder vectors or matrices and to indicate them in the CSI report.

### Spatial-Domain Components of the Precoder

In certain embodiments, the wireless device is configured to determine one or more spatial domain, SD, components for the set of linear combination coefficients of the precoder. Each SD component corresponds to a basis vector. A set of SD components may correspond to a first basis set. For determining the precoder vectors or matrices, the wireless device is configured to select one or more SD components from the first basis set. A basis vector from the first basis set is associated with a set of antenna ports or CSI-RS ports of an antenna port group. The set of antenna ports or CSI-RS ports may be associated with a first and second polarization. A first set of antenna or CSI-RS ports may be associated with a first polarization, and a second set of antenna or CSI-RS ports may be associated with a second polarization. The selection of the one or more basis vectors (one or more SD components) from the first basis set can be polarization-common or polarization-specific. In case of polarization-common selection, the selected basis vectors from the first basis set are common to the two polarizations of the antenna or CSI-RS ports configured to the wireless device. In case of polarization-specific selection, the selected basis vectors from the first set are independently selected by the wireless device for the two polarizations of the antenna or CSI-RS ports configured to the wireless device. In an exemplary embodiment, the wireless device selects L basis vectors of the precoding vector or matrix from the first basis set, and indicates the selected L basis vectors in the CSI report. In some examples, the selected L basis vectors are polarization-common, and hence identical for the first and second set of antenna or CSI-RS ports. In some examples, the selected L basis vectors are polarization-dependent, and hence possibly different to the first or second set of antenna or CSI-RS ports. In some examples, the selected L basis vectors are layer-dependent and differ for a subset of transmission layers or per transmission layer of the precoder. In such a case, the basis vectors are selected independently per layer subset or layer of the precoder. In some other examples, the selected L basis vectors are layer-independent and identical for all layers of the precoder.

In certain embodiments, the first basis set is an orthogonal basis set, i.e., the basis set comprises a number of orthogonal basis vectors. For example, the first basis set is a DFT- or DCT-based basis set. In certain embodiments, the first basis set is defined by an DFT or IDFT basis set, or an oversampled DFT or IDFT basis set. In certain embodiments, the first basis set comprises a set of Discrete Cosine Transform (DCT)-based vectors. When the first basis set is defined by an DFT-based (DFT or IDFT) basis set, the first basis set is represented by a DFT- or IDFT-matrix. In certain embodiments, the first basis set is defined by a rotated DFT-based basis, wherein the indices of the DFT-based vectors are defined by i₁=O₁i₁₁+q₁, i₁₁=0, . . . , N₁−1, i₂=O₂i₂₂+q₂, i₂₂=0, . . . , N₂−1 with q₁=0, . . . , O₁−1 q₂=0, . . . , O₂−1 be the rotation factors of the rotated DFT-based basis, N₁ and N₂ denote the antenna ports with respect to a first and a second dimension, respectively, and O₁ and O₂ denote the oversampling factors with respect to the first and second dimension, respectively. In such cases, the rotated DFT-based basis is selected from an oversampled DFT-based basis comprising O₁O₂N₁N₂ DFT-based vectors. The rotation factors may be selected by the wireless device, or configured to the wireless device, or reported by the wireless device as a part the CSI-report. The oversampling factors may be fixed in the 3GPP specifications and hence known to the wireless device. The two parameters N₁ and N₂ may depend on a CSI-RS resource and can be different for different CSI-RS resources indicated in the CSI report configuration.

In certain embodiments, the first basis set is an orthogonal basis set, i.e., the basis set comprises a number of orthogonal basis vectors comprising an identity matrix. Each vector of size P_{CSI-RS} or P_{CSI-RS}/2 from the basis set is associated with a CSI-RS port and comprises P_{CSI-RS}−1 or

$$\frac{{P}_{CSI - RS}}{2} - 1$$

zeros and a single one, wherein P_{CSI-RS} or P_{CSI-RS}/2 (e.g., per polarization of the antenna ports) is the number of antenna ports of one or multiple antenna port groups. In some examples, P_{CSI-RS} may depend on the CSI-RS resource and can be different for different CSI-RS resources.

In certain embodiments, there are multiple first basis sets, wherein each first basis set is associated with a CSI-RS resource. The dimensions of each basis set may depend on N₁, N₂, and or P_{CSI-RS} which can be identical or different for different CSI-RS resources. The parameter L may be dependent on the CSI-RS resource. When N CSI-RS resources are selected by the wireless device from N_{TRP} configured CSI-RS resources, there are Lₙ, n=0, . . . , N−1 parameters, wherein Lₙ represents the number of SD components selected by the wireless device from a first basis set associated with a n-th CSI-resource.

### Frequency-Domain Components of the Precoder

In certain embodiments, the wireless device is configured to determine one or more frequency domain, FD, components for the set of linear combination coefficients of the precoder. Each frequency-domain, FD, component of the precoder corresponds to a basis vector. A set of FD components corresponds to a second basis set. For determining the precoder vectors or matrices, the wireless device is configured to select one or more FD components (i.e., basis vectors) from the second basis set. A basis vector from the second basis set is associated with a number of subbands, N₃, of the bandwidth of the DL channel. A subband may comprise a number of Physical Resource Blocks (PRBs). In certain embodiments, the number of subbands, N₃, is dependent on the number of CQI subbands, or on the CQI subband size configured to the wireless device.

In certain embodiments, the second basis set is defined by an orthogonal basis set, i.e., the basis set comprises a number of orthogonal vectors. For example, the second basis set is a DFT- or DCT-based basis. In certain embodiments, the second basis set is defined by an DFT or IDFT basis, or an oversampled DFT or IDFT basis. In certain embodiments, the second basis set comprises a set of Discrete Cosine Transform (DCT)-based vectors. When the second basis set is defined by an DFT-based (DFT or IDFT) basis, the second basis set may be represented by a DFT- or IDFT-matrix. In certain embodiments, the second basis set is defined by a rotated DFT-based basis, wherein the indices of the DFT-based vectors are defined by d₃=O₃i₃+q₃, i₃=0, . . . , N₃−1 with q₃=0, . . . , O₃−1 be the rotation factor of the rotated DFT-based basis. In such cases, the rotated DFT-based basis is selected from an oversampled DFT-based basis comprising O₃N₃ DFT-based vectors. This means, the basis set corresponding to the frequency-domain components is an oversampled DFT- or DCT-based matrix comprising O₃ orthogonal DFT- or DCT-based matrices. The rotation factor may be selected by the wireless device, or configured to the wireless device, or reported by the wireless device as a part the CSI-report. In certain embodiments, the number of frequency subbands defines the length (N₃) of the basis vectors of the second basis set. The number of frequency subbands may be indicated to the wireless device, e.g., via a higher layer, or may be fixed in the NR specifications and known by the wireless device or selected by the wireless device and indicated in the CSI-report.

In certain embodiments, the set of FD components is a basis set represented by DFT-based or DCT-based matrix or an oversampled DFT-based or DCT-based matrix, and the basis set comprises a number of basis vectors that represent the FD components, and each basis vector is a DFT- or DCT-based vector.

In certain embodiments, the basis vector set of the FD components is an oversampled DFT- or DCT-based matrix comprising O₃ orthogonal DFT- or DCT-based matrices.

In certain embodiments, the wireless device selects M FD components from the second basis set for the precoding matrix or vector across N selected CSI-RS resources.

In certain embodiments, the wireless device selects M FD components from the second basis set for the precoding matrix or vector per CSI-RS resource for N selected CSI-RS resources. In certain embodiments, the parameter M is configured to the wireless device, selected and reported from the wireless device to a network node, derived from another parameter such as N₃, or it is fixed in the 3GPP NR specifications and hence known to the wireless device.

### Structure of Precoder Matrix

In accordance with an embodiment, the precoder matrix or vector indicated in the CSI report may be associated with N selected CSI-RS resources out of N_{TRP} configured CSI-RS resources, wherein the CSI-RS resources are indicated in the CSI report configuration. The precoder matrix comprises N precoder matrices or vectors, wherein each precoder matrix or vector is associated with a CSI-RS resource.

The precoding vector or precoding matrix W^{l} for the l-th transmission layer is defined over a number of frequency units/PRBs or frequency domain precoder units (N₃) and spatial units (2N₁N₂ or P_{CSI-RS}) for N selected CSI-RS resources. In an exemplary embodiment, the precoding vector or precoding matrix W^{l} of the I-th transmission layer and g-th CSI-RS resource is defined by:

$${W}^{g , l} = α {W}_{1 , g , l} {W}_{2 , g , l} {W}_{f , g , l}^{H} , or$$

$${W}^{g , l} = α {\sum }_{m = 0}^{2 {L}_{v} - 1} {\sum }_{i = 0}^{{M}_{v} - 1} {c}_{g , l , m , i} ( {b}_{g , l , m} {a}_{g , l , m , i}^{H} ) = α {\sum }_{i = 0}^{{M}_{v} - 1} {\sum }_{m = 0}^{2 {L}_{v} - 1} {c}_{g , l , m , i} ( {b}_{g , l , m} {a}_{g , l , m , i}^{H} ) , or$$

$${W}^{g , l} = α [ \begin{matrix}{\sum }_{m = 0}^{{L}_{v} - 1} {\sum }_{i = 0}^{{M}_{v} - 1} {c}_{g , l , m , i} ( {b}_{g , l , m} {a}_{g , l , m , i}^{H} ) \\ {\sum }_{m = 0}^{{L}_{v} - 1} {\sum }_{i = 0}^{{M}_{v} - 1} {c}_{g , l , m + {L}_{v} , i} ( {b}_{g , l , m + {L}_{v}} {a}_{g , l , m + {L}_{v} , i}^{H} )\end{matrix} ] ,$$

where:
W_{1,g,l} is a matrix comprising Ly selected basis vectors from the first basis set,
W_{2,g,l} is a coefficient matrix,

$${W}_{f , g , l}^{H}$$

is a matrix comprising Mᵥ basis vectors, where each vector is associated with the N₃ frequency units of the precoder matrix,
b_{g,l,m} is a N₁N₂×1 or P×1 basis vector associated with the antenna ports of the g-th antenna or CSI-RS port group of the precoder matrix,
a_{g,l,m,i} is a N₃×1 basis vector associated with the N₃ frequency units of the precoder matrix,
c_{g,l,m,i} is a complex precoder coefficient or combining coefficient,
α is a normalization factor.

In accordance with an embodiment, the precoder matrix may comprise multiple precoder matrices, wherein each precoder matrix is associated with an antenna port group or CSI-RS port group.

In certain embodiments, the matrices comprising the selected FD components are independent on the CSI-RS resource such that

$${W}_{f , l}^{H} = {W}_{f , g , l}^{H} , ∀ g .$$

This means there is only a single matrix

$${W}_{f , l}^{H} .$$

There is only a single HD indicator for the selected FD components in the CSI report per layer or subset of layers or all layers of the precoding matrix.

### Number of Frequency Units/Subbands:

In accordance with an embodiment, the wireless device is configured to determine the dimension of the second basis set N₃ based on a parameter Q and a number of CQI subbands N_{CQI} as N₃=┌Q·N_{CQI}┐, wherein the parameter Q is higher layer configured to the wireless device, selected by the wireless device or known to the wireless device, e.g., fixed in the 3GPP NR specifications.

### Selection of Basis Vectors and Indication in CSI Report

In certain embodiments, the wireless device determines a set of combining coefficients for combining the selected SD component(s) and FD component(s) for the precoder. The wireless device generates and transmits, to a network node or other wireless device, a CSI report, the CSI report comprising an indication of the selected one or more SD components, and an indication of the selected one or more FD components, and an indication of the combining coefficients of the precoder vector or matrix.

In accordance with embodiments, the UE is configured to select Lₙ basis vectors for a n-th selected CSI-RS resource from a first basis set for a number of antenna or CSI-RS port groups of the precoder matrix. The parameter Lₙ can be different for a number of N selected CSI-RS resources. In some examples, the parameter Lₙ may be identical for all v transmission layers of the precoder matrix. The parameter(s) Lₙ may be configured to the UE, or reported by the UE, or fixed in the NR specifications and known to the UE.

In accordance with embodiments, the UE is configured to indicate the one or more selected basis vector(s) from the first basis set or multiple first basis sets in the CSI report. In some examples, the UE reports a

$$⌈ {log}_{2} ( \begin{matrix}{N}_{1} {N}_{2} \\ {L}_{n}\end{matrix} ) ⌉$$

bit indicator per CSI-RS resource indicating the selected Lₙ basis vectors.

In accordance with embodiments, the UE indicates the selected basis vectors from the second basis set per selected CSI-RS resource or across all selected N CSI-RS resources by one or more indicator(s) per transmission layer or subset of transmission layer(s) of the precoder matrix in the CSI report. For example, such an indicator may be given by a

$$⌈ {log}_{2} ( \begin{matrix}{N}_{3} \\ {M}_{v}\end{matrix} ) ⌉ or ⌈ {log}_{2} ( \begin{matrix}{N}_{3} - 1 \\ {M}_{v} - 1\end{matrix} ) ⌉$$

combinatorial bit indicator, wherein N₃ and Mᵥ denote the number of basis vectors from the second set and the number of selected basis vectors from the second set for layer v of the precoder matrix, respectively, for a selected CSI-RS resource or across all N CSI-RS resources. The parameter Mᵥ may be identical or different for the N CSI-RS resources associated with the precoder matrix.

In the following, it is assumed that the number of selected basis vectors, Mᵥ, from the second basis set is either configured via a higher layer (e.g., RRC), or fixed in the NR specifications and hence known to the UE or reported by the UE.

### UCI Omission

Uplink control information, UCI, omission occurs when the uplink resources provided by a base station or by a network node to the wireless device or user equipment for an uplink transmission is not sufficient to carry the entire content of one or more CSI report(s). The CSI payload of a CSI report can be controlled by the UE by the number of precoder coefficients to be reported. In case of UCI or CSI omission, the UE can simply reduce the number of precoder coefficients to be reported for one or more of the CSI reports based on the available uplink resources (e.g., available PUSCH resources). However, such a reduction of the number of precoder combining coefficients would require a recalculation of the precoder coefficients, all basis vectors associated with the precoder vector or matrix for the one or more CSI reports, occupying additional UE resources. Such additional UE resources may not be available at the UE. Therefore, a UCI omission scheme should not require a recalculation of precoder vector or matrix for the one or more CSI reports.

In accordance with embodiments, the uplink resource or uplink control information (UCI) may contain the one or more reduced-size CSI report(s), wherein the UCI may comprise a UCI or CSI part 1 and a UCI or CSI part 2. In some examples, the UCI or CSI part 1 may comprise an indication of the number of precoder (amplitude and/or phase) combining coefficients per layer or across all layers of the precoder vector or matrix for the one or more CSI report(s). In some examples, the UCI or CSI part 1 may comprise one or more rank indication or a rank index (RI) for the one or more CSI report(s) indicating the number of layers of the precoder vector or matrix in the CSI report.

In accordance with embodiments, the UE is configured to receive an uplink resource allocation from a base station for an uplink transmission of one or more CSI reports. The UE may determine that the size of the resource allocation is not sufficient to carry the entire content(s) of the CSI report(s). In such cases, the UE may perform a CSI or UCI omission procedure to determine one or more reduced-size CSI report(s) that fit within the uplink resource allocation. The one or more reduced-size CSI report(s) may be transmitted over an uplink channel to a network node, like a base station, gNB.

In one embodiment, the CSI omission procedure is based on dropping a portion of the amplitude and phase coefficients of the precoder or combining coefficients of the one or more CSI report(s). This means the UE is configured to omit a portion of the one or more CSI report(s), and thereby provide one or more reduced-size CSI report(s) for the transmission over an uplink channel to a network node, like a base station, gNB.

In accordance with embodiments, the set of combining coefficients are segmented for each CSI report into two or more CSI groups for UCI or CSI omission, wherein for the combining coefficients a certain ordering is applied and the combining coefficients are segmented or divided into two or more CSI groups. Moreover, each CSI report and each CSI group may be associated with a priority level.

In one embodiment, the CSI or UCI omission procedure is based on dropping one or more CSI groups and hence the associated phase and amplitude of the combining coefficients of the precoder vector or matrix of the associated CSI report according to a priority rule. Hence, in case of CSI or UCI omission, a part of the amplitude and/or phase coefficients of the precoder vector or matrix indicated in the CSI report is omitted.

In accordance with embodiments, the UE may drop the CSI groups in case of UCI or CSI omission with lower priority until the payload size of the CSI report(s) fits with the resource allocation from the network node, like a base station, gNB. When omitting a CSI group for a particular priority level, the UE may omit all the CSI content at that priority level.

In the following embodiments, ordering schemes for the bits in the bitmap and hence the combining coefficients are proposed. It is assumed that the ordering for the combining coefficients in the at least two CSI groups follows the ordering of the bits of the bitmap. The aim of the ordering of the combining coefficients is to reduce performance degradation in case of UCI or CSU omission, i.e., when one or more CSI groups are dropped from a CSI report.

### Selection and Indication of Non-Zero Combining Coefficients in CSI Report

In certain embodiments, the wireless device is configured to select M FD components for the precoding matrix and to indicate the selected M FD components for N selected CSI-RS resources in the CSI report.

In certain embodiments, the wireless device is configured to select Lₙ SD components for the precoding matrix and to indicate the selected Lₙ SD components associated with a n-th CSI-RS resource in the CSI report.

Note that the SD components are identical for both polarizations of the antenna ports associated with a TRP or panel or RRH or CSI-RS resource. Hence, the precoding matrix is associated with

$$2 {\sum }_{n = 0}^{N - 1} {L}_{n}$$

SD components, where the Lₙ SD components are identical for both polarizations for all n=0, . . . , N−1.

In certain embodiments, the wireless device selects

$$2 {\sum }_{n = 0}^{N - 1} {L}_{n} M$$

combining coefficients, where Lₙ is a number of spatial-domain, SD, components associated with the n-th selected CSI-RS resource, and M is a number of frequency-domain, FD, components. The number of SD and FD components are either selected and reported by the wireless device, or higher layer configured (e.g., via RRC) to the UE, or fixed in the specification and known to the wireless device.

To reduce the feedback overhead, the wireless device may be configured to determine K or less than K non-zero combining coefficients out of the

$$2 {\sum }_{n = 0}^{N - 1} {L}_{n} M$$

combining coefficients. The K non-zero combining coefficients are reported (as a part of the CSI report) by the wireless device to a network node (e.g., gNB). The value of K is configured to the wireless device, fixed in the 3GPP specifications and hence known to the wireless device, or selected and reported from the wireless device to a network node.

In certain embodiments, the wireless device determines a bitmap of size

$$2 {\sum }_{n = 0}^{N - 1} {L}_{n} M$$

indicating the location of the selected non-zero combining coefficients. The bitmap comprises 1's and 0's. A ‘1’ is associated with a selected non-zero combining coefficient and a ‘0’ is associated with a zero or non-selected combining coefficient, or vice versa. In some examples, the bitmap is selected per layer of the precoding matrix. The bitmap is a part of the CSI report.

In certain embodiments, the wireless device is configured to indicate in the CSI report the location of the selected non-zero coefficients using a

$$⌈ {log}_{2} ( \begin{matrix}2 {\sum }_{n = 0}^{N - 1} {L}_{n} M \\ K\end{matrix} ) ⌉ - bit indicator .$$

In certain embodiments, the UE is configured to select N TRPs or CSI-RS resources out of N_{TRP} configured TRPs or CSI-RS resources. The precoding matrix indicated in the CSI report is then defined for the N selected CSI-RS resources or TRPs.

In certain embodiments, the maximum number of non-zero combining coefficients per layer across all N selected CSI-RS resources or TRPs is given by K₀. In certain embodiments, for RI>1, the maximum number of non-zero combining coefficients summed across all layers and across all N selected CSI-RS resources or TRPs is given by 2K₀.

In certain embodiments, the wireless device reports a bitmap (in the CSI report), the bitmap comprising

$${\sum }_{n = 0}^{N - 1} 2 {L}_{n} {M}_{n} {R}_{n}$$

bit fields, wherein each bit is associated with a TRP index (n), SD component index (lₙ), FD component index (mₙ), a rank index (rₙ), wherein lₙ=0, . . . , 2Lₙ−1, mₙ=0, . . . , Mₙ−1, and rₙ=0, . . . , Rₙ−1, and, Lₙ, Mₙ, and Rₙ, denote the CSI-RS resource specific number of SD components, CSI-RS resource specific number of FD components, and CSI-RS resource specific supported rank value or number of layers for the n-th CSI-RS resource, respectively.

In the following embodiments, it is assumed that each bit is associated with a combining coefficient, wherein a ‘0’ indicates that the associated combining coefficient is not reported and a ‘1’ indicates that the associated combining coefficient is reported.

In certain embodiments, the ordering of the amplitude and phase information of the combining coefficients follows the ordering of the bits or bit fields in the bitmap in the CSI report.

In certain embodiments, the non-zero combining coefficients of the precoding matrix associated with the strongest TRP or CSI-RS resource are contained in CSI group 1, wherein the combining coefficients of the strongest TRP or CSI-RS resource comprise the strongest coefficient indicated by a strongest coefficient indicator. Note that the amplitude and/or phase of the strongest coefficient are not reported. In certain embodiments, the strongest coefficient indicator is the strongest coefficient indicator associated with the first layer of the precoding matrix.

In certain embodiments, the non-zero combining coefficients of the precoding matrix associated with the strongest TRP or CSI-RS resource are contained in CSI group 1, wherein the reference amplitude of the non-zero combining coefficients associated with the strongest TRP or CSI-RS resource is given by a value of ‘1’ and not reported.

### Ordering Scheme for Bitmap

### Grouping Scheme 1:

In certain embodiments, the

$${\sum }_{n = 0}^{N - 1} 2 {L}_{n} {M}_{n} {R}_{n}$$

bit fields are grouped into N groups, wherein N is the number of selected TRPs or CSI-RS resources. Each of the N groups are associated with TRP or CSI-RS resource index and comprises 2LₙMₙRₙ bits. In certain embodiments, the N groups each comprising 2LₙMₙRₙ bits are ordered in an increasing order from left to right with respect to a TRP or CSI-RS resource index or a re-mapped TRP or CSI-RS resource index.
Option 1a+Option 1b

In certain embodiments, the 2LₙMₙRₙ bits in each group are further grouped into Rₙ sub-groups each comprising 2LₙMₙ bits, wherein the rₙ-th sub-group is associated with a layer of the precoding matrix. In option 1a, the 2LₙMₙ bits of each group are further grouped into Mₙ sub-groups each comprising 2Lₙ bits, and wherein all bits of the mₙ-th sub-group are associated with the same FD component index. Each bit of the 2Lₙ bits is associated with a different SD index. In option 1b, the 2LₙMₙ bits are further grouped into 2Lₙ sub-groups each comprising Mₙ bits, and wherein all bits of the lₙ-th sub-group are associated with the same SD component index. Each bit of the Mₙ bits is associated with a different FD component index.

In certain embodiments, the Rₙ sub-groups each comprising 2LₙMₙ bits are ordered in an increasing order from left to right. In option 1a, the Mₙ sub-groups each comprising 2Lₙ bits are ordered in an increasing order from left to right with respect to the FD index or a re-mapped FD index. The 2Lₙ bits in each sub-group are ordered in an increasing order from left to right with respect to the SD index or a re-mapped SD index. In option 1b, the 2Lₙ sub-groups each comprising Mᵥ bits are ordered in an increasing order from left to right with respect to the SD index or a re-mapped SD index. The Mₙ bits in each sub-group are ordered in an increasing order from left to right with respect to the FD index or a re-mapped FD index.

Option 1c+Option 1d

In certain embodiments, the 2LₙMₙRₙ bits in each group are further grouped into Mₙ sub-groups each comprising 2LₙRₙ bits, wherein the mₙ-th sub-group is associated with an FD component of the precoding matrix. In option 1c, the 2LₙRₙ bits are further grouped into Rₙ sub-groups each comprising 2Lₙ bits, and wherein all bits of the rₙ-th sub-group are associated with the same layer index. Each bit of the 2Lₙ bits is associated with a different SD component index. In option 1d, the 2LₙRₙ bits are further grouped into 2Lₙ sub-groups each comprising Rₙ bits, and wherein all bits of the lₙ-th sub-group are associated with the same SD component index. Each bit of the Rₙ bits is associated with a different layer index.

In certain embodiments, the Mₙ sub-groups each comprising 2LₙRₙ bits are ordered in an increasing order from left to right with respect to the FD index or a re-mapped FD index. In option 1c, the Rₙ sub-groups each comprising 2Lₙ bits are ordered in an increasing order from left to right. The 2Lₙ bits in each sub-group are ordered in an increasing order from left to right with respect to the SD index or a re-mapped SD index. In option 1d, the 2Lₙ sub-groups each comprising Rₙ bits are ordered in an increasing order from left to right with respect to the SD index or a re-mapped SD index. The Rₙ bits in each sub-group are ordered in an increasing order from left to right.

Option 1e+Option 1f:
In certain embodiments, the 2LₙMₙRₙ bits in each group are further grouped into 2Lₙ sub-groups each comprising MₙRₙ bits, wherein the lₙ-th sub-group is associated with an SD component of the precoding matrix. In option 1e, the MₙRₙ bits are further grouped into Mₙ sub-groups each comprising Rₙ bits, and wherein all bits of the mₙ-th sub-group are associated with the same FD component index. Each bit of the Rₙ bits is associated with a layer index. In option 1e, the MₙRₙ bits are further grouped into Rₙ sub-groups each comprising Mₙ bits, and wherein all bits of the rₙ-th sub-group are associated with the same layer index. Each bit of the M bits is associated with an FD component index.

In certain embodiments, the 2Lₙ sub-groups each comprising MₙRₙ bits are ordered in an increasing order from left to right with respect to the SD index or a re-mapped SD index. In option 1e, the Mₙ sub-groups each comprising Rₙ bits are ordered in an increasing order from left to right with respect to the FD index or a re-mapped FD index. The Rₙ bits in each sub-group are ordered in an increasing order from left to right. In option 1f, the Rₙ sub-groups each comprising Mₙ bits are ordered in an increasing order from left to right. The Mₙ bits in each sub-group are ordered in an increasing order from left to right with respect to the FD index or a re-mapped FD index.

### Grouping Scheme 2:

In certain embodiments, the

$${\sum }_{n = 0}^{N - 1} 2 {L}_{n} {M}_{n} {R}_{n}$$

bit fields are grouped into R groups, wherein R is the maximum supported rank value N selected TRPs or CSI-RS resources. Each group is associated with a r-th layer index and comprises a maximum of

$${\sum }_{n = 0}^{N - 1} 2 {L}_{n} {M}_{n}$$

bits. For Rₙ<R, the 2LₙMₙRₙ bits associated with the n-th TRP or CSI-RS resource index are present only in the first Rₙ groups. The R groups are ordered in an increasing order from left to right.
Option 2a+Option 2b

In certain embodiments, the

$${\sum }_{n = 0}^{N - 1} 2 {L}_{n} {M}_{n}$$

bits in each group are further grouped into N sub-groups each comprising 2LₙMₙ bits, wherein the n-th sub-group is associated with a TRP or a CSI-RS resource index. In option 2a, the 2LₙMₙ bits are further grouped into 2Lₙ sub-groups each comprising Mₙ bits, and wherein all bits of the lₙ-th sub-group are associated with the same SD component index. Each bit of the Mᵥ bits is associated with an FD component index. In option 2b, the 2LₙMₙ bits are further grouped into Mₙ sub-groups each comprising 2Lₙ bits, and wherein all bits of the mₙ-th sub-group are associated with the same FD component index. Each bit of the 2Lₙ bits is associated with an SD component index.

In certain embodiments, the N sub-groups each comprising 2LₙMₙ bits are ordered in an increasing order from left to right with respect to a TRP or CSI-RS resource index or a re-mapped TRP or CSI-RS resource index. In option 2a, the 2Lₙ sub-groups each comprising Mₙ bits are ordered in an increasing order from left to right with respect to the SD index or a re-mapped SD index. The Mₙ bits in each sub-group are ordered in an increasing order from left to right with respect to the FD index or a re-mapped FD index. In option 2b, the Mₙ sub-groups each comprising 2Lₙ bits are ordered in an increasing order from left to right with respect to the FD index or a re-mapped FD index. The 2Lₙ bits in each sub-group are ordered in an increasing order from left to right with respect to the SD index or a re-mapped SD index.

Option 2c+Option 2d

In certain embodiments, the

$${\sum }_{n = 0}^{N - 1} 2 {L}_{n} {M}_{n}$$

bits in each group are further grouped into 2L sub-groups, wherein L is the maximum number of selected SD components across N selected TRPs or CSI-RS resources. The I-th sub-group is associated with an SD index and comprises

$${\sum }_{n = 0}^{N - 1} {M}_{n}$$

bits. For Lₙ<L, the Mₙ bits associated with the n-th TRP or CSI-RS resource index are present only in the first 2Lₙ sub-groups. In option 2c, the

$${\sum }_{n = 0}^{N - 1} {M}_{n}$$

bits in each sub-group are further grouped into N sub-groups each comprising Mₙ bits, wherein all bits of the n-th sub-group are associated with the same TRP or CSI-RS resource index. Each bit of the Mₙ bits is associated with a different FD index. In option 2d, the

$${\sum }_{n = 0}^{N - 1} {M}_{n}$$

bits in each sup-group are further grouped into M sub-groups, wherein M is the maximum number of selected FD components across N selected TRPs or CSI-RS resources. For Mₙ<M, the bit associated with the n-th TRP or CSI-RS resource index is present only in the first Mₙ groups. All bits of the m-th subgroup are associated with the same FD index. Each bit of the m-th subgroup is associated with a different TRP or CSI-RS resource index.

In certain embodiments, the 2L sub-groups are ordered in an increasing order from left to right with respect to the SD index or a re-mapped SD index. In option 2c, the N sub-groups each comprising Mₙ bits are ordered in an increasing order from left to right with respect to a TRP or CSI-RS resource index or a re-mapped TRP or CSI-RS resource index. The Mₙ bits in each sub-group are ordered in an increasing order from left to right with respect to the FD index or a re-mapped FD index. In option 2d, the Mₙ sub-groups are ordered in an increasing order from left to right with respect to the FD index or a re-mapped FD index. The bits in each sub-group are ordered in an increasing order from left to right with respect to a TRP or CSI-RS resource index or a re-mapped TRP or CSI-RS resource index.

Option 2e+Option 2f:

In certain embodiments, the

$${\sum }_{n = 0}^{N - 1} 2 {L}_{n} {M}_{n}$$

bits in each group are further grouped into M sub-groups, wherein M is the maximum number of selected FD components across N selected TRPs or CSI-RS resources. Each m-th sub-group is associated with an FD component index and comprises

$${\sum }_{n = 0}^{N - 1} 2 {L}_{n}$$

bits. For Mₙ<M, the 2Lₙ bits associated with the n-th TRP or CSI-RS resource index are present only in the first Mₙ groups. In option 2e, the

$${\sum }_{n = 0}^{N - 1} 2 {L}_{n}$$

bits in each sub-group are further grouped into N sub-groups each comprising 2Lₙ bits, wherein all bits of the n-th sub-group are associated with the same TRP or CSI-RS resource index. Each bit of the 2Lₙ bits is associated with an SD component index. In option 2f, the

$${\sum }_{n = 0}^{N - 1} 2 {L}_{n}$$

bits in each sub-group are further grouped into 2L sub-groups, wherein L is the maximum number of selected SD components across N selected TRPs or CSI-RS resources. For Lₙ<L, the bit associated with the n-th TRP or CSI-RS resource index is present only in the first 2Lₙ groups. All bits of the l-th subgroup are associated with the same SD component index. Each bit in the l-th subgroup is associated with a TRP or CSI-RS resource index.

In certain embodiments, the M sub-groups are ordered in an increasing order from left to right with respect to the FD index or a re-mapped FD index. In option 2e, the N sub-groups are ordered in an increasing order from left to right with respect to a TRP or CSI-RS resource index or a re-mapped TRP or CSI-RS resource index. The 2Lₙ bits are ordered in an increasing order from left to right with respect to the SD index or a re-mapped SD index. In option 2f, the 2L sub-groups are ordered in an increasing order from left to right with respect to the SD index or a re-mapped SD index. The bits of each sub-group are ordered in an increasing order from left to right with respect to a TRP or CSI-RS resource index or a re-mapped TRP or CSI-RS resource index.

### Grouping Scheme 3:

In certain embodiments, the

$${\sum }_{n = 0}^{N - 1} 2 {L}_{n} {M}_{n} {R}_{n}$$

bit fields are grouped into M groups, wherein M is the maximum number of selected FD components across N selected TRPs or CSI-RS resources. Each group is associated with a m-th FD index and comprises

$${\sum }_{n = 0}^{N - 1} 2 {L}_{n} {R}_{n}$$

bits. For Mₙ<M, the 2LₙRₙ bits associated with the n-th TRP or CSI-RS resource index are present only in the first Mₙ groups. In certain embodiments, the M groups are ordered in an increasing order from left to right with respect to the FD index or a re-mapped FD index.
Option 3a+Option 3b:

In certain embodiments, the

$${\sum }_{n = 0}^{N - 1} 2 {L}_{n} {R}_{n}$$

bits in each group are further grouped into N sub-groups each comprising 2LₙRₙ bits, wherein the n-th sub-group is associated with a TRP or CSI-RS resource index. In option 3a, the 2LₙRₙ bits are further grouped into 2Lₙ sub-groups each comprising Rₙ bits, and wherein all bits of the lₙ-th sub-group are associated with the same SD component index. Each bit of the Rₙ bits is associated with a layer index. In option 3b, the 2LₙRₙ bits are further grouped into Rₙ sub-groups each comprising 2Lₙ bits, and wherein all bits of the rₙ-th sub-group are associated with the same layer index. Each bit of the 2Lₙ bits is associated with an SD component index.

In certain embodiments, the M groups are ordered in an increasing order from left to right with respect to the FD index or a re-mapped FD index. The N sub-groups each comprising 2LₙRₙ bits are ordered in an increasing order from left to right with respect to a TRP or CSI-RS resource index or a re-mapped TRP or CSI-RS resource index. In option 3a, the 2Lₙ sub-groups each comprising Rₙ bits are ordered in an increasing order from left to right with respect to the SD index or a re-mapped SD index The Rₙ bits of each sub-group are ordered in an increasing order from left to right. In option 3b, the Rₙ sub-groups each comprising 2Lₙ bits are ordered in an increasing order from left to right. The 2Lₙ bits of each sub-group are ordered in an increasing order from left to right with respect to the SD index or a re-mapped SD index.

Option 3c+Option 3d:

In certain embodiments, the

$${\sum }_{n = 0}^{N - 1} 2 {L}_{n} {R}_{n}$$

bits in each group are further grouped into 2L sub-groups, wherein L is the maximum number of selected SD components across N selected TRPs or CSI-RS resources. Each l-th sub-group is associated with an SD component index and comprises

$${\sum }_{n = 0}^{N - 1} {R}_{n}$$

bits. For Lₙ<L, the Rₙ bits associated with the n-th TRP or CSI-RS resource index are present only in the first 2Lₙ groups. In option 3c, the

$${\sum }_{n = 0}^{N - 1} {R}_{n}$$

bits in each sub-group are further grouped into N sub-groups each comprising Rₙ bits, wherein all bits of the n-th sub-group are associated with the same TRP or CSI-RS resource index. Each bit of the Rₙ bits is associated with a layer index. In option 3d, the

$${\sum }_{n = 0}^{N - 1} {R}_{n}$$

bits in each sub-group are further grouped into R sub-groups, wherein R is the maximum supported rank value across N selected TRPs or CSI-RS resources. For Rₙ<R, the bits associated with the n-th TRP or CSI-RS resource index are present only in the first Rₙ groups. All bits of the r-th subgroup are associated with the same layer index. Each bit in the r-th is associated with a TRP or CSI-RS resource index.

In certain embodiments, the 2L sub-groups are ordered in an increasing order from left to right with respect to the SD index or a re-mapped SD index. In option 3c, the N sub-groups each comprising Rₙ bits are ordered in an increasing order from left to right with respect to a TRP or CSI-RS resource index or a re-mapped TRP or CSI-RS resource index. The Rₙ bits are ordered in an increasing order from left to right. In option 3d, the R sub-groups are ordered in an increasing order from left to right. The bits in the r-th sub-group are ordered in an increasing order from left to right with respect to a TRP or CSI-RS resource index or a re-mapped TRP or CSI-RS resource index.

Option 3e+Option 3f:

In certain embodiments, the

$${\sum }_{n = 0}^{N - 1} 2 {L}_{n} {R}_{n}$$

bits in each group are further grouped into R sub-groups, wherein R is the maximum supported rank value across N selected TRPs or CSI-RS resources. Each r-th sub-group is associated with a layer index and comprises

$${\sum }_{n = 0}^{N - 1} 2 {L}_{n}$$

bits. For Rₙ<R, the 2Lₙ bits associated with the n-th TRP or CSI-RS resource index are present only in the first Rₙ groups. In option 3e, the

$${\sum }_{n = 0}^{N - 1} 2 {L}_{n}$$

bits in each sub-group are further grouped into N sub-groups each comprising 2Lₙ bits, wherein all bits of the n-th sub-group are associated with the same TRP or CSI-RS resource index. Each bit of the 2Lₙ bits is associated with an SD component index. In option 3f, the

$${\sum }_{n = 0}^{N - 1} 2 {L}_{n}$$

bits in each sub-group are further grouped into 2L sub-groups, wherein L is the maximum number of selected SD components across N selected TRPs or CSI-RS resources. For Lₙ<L, the bit associated with the n-th TRP or CSI-RS resource index is present only in the first 2Lₙ groups. All bits of the l-th subgroup are associated with the same SD component index. Each bit in the l-th subgroup is associated with a TRP or CSI-RS resource index.

In certain embodiments, the R sub-groups are ordered in an increasing order from left to right. In option 3e, the N sub-groups each comprising

$${\sum }_{n = 0}^{N - 1} 2 {L}_{n}$$

are ordered in an increasing order from left to right with respect to a TRP or CSI-RS resource index or a re-mapped TRP or CSI-RS resource index. The 2Lₙ bits are ordered in an increasing order from left to right with respect to the SD index or a re-mapped SD index. In option 3f, the 2L sub-groups are ordered in an increasing order from left to right with respect to the SD index or a re-mapped SD index The bits in each sub-group are ordered from left to right with respect to a TRP or CSI-RS resource index or a re-mapped TRP or CSI-RS resource index.

### Grouping Scheme 4:

In certain embodiments, the

$${\sum }_{n = 0}^{N - 1} 2 {L}_{n} {M}_{n} {R}_{n}$$

bit fields are grouped into 2L groups, wherein L is the maximum number of selected SD components across N selected TRPs or CSI-RS resources. Each group is associated with a l-th SD index and comprises

$${\sum }_{n = 0}^{N - 1} {M}_{n} {R}_{n}$$

bits. For Lₙ<L, the MₙRₙ bits associated with the n-th TRP or CSI-RS resource index are present only in the first 2Lₙ groups.

In certain embodiments, the 2L groups are ordered in an increasing order from left to right with respect to the SD index or a re-mapped SD index.

Option 4a+Option 4b:

In certain embodiments, the

$${\sum }_{n = 0}^{N - 1} {M}_{n} {R}_{n}$$

bits in each group are further grouped into N sub-groups each comprising MₙRₙ bits, wherein the n-th sub-group is associated with a TRP or CSI-RS resource index. In option 4a, the MₙRₙ bits are further grouped into Mₙ sub-groups each comprising Rₙ bits, and wherein all bits of the mₙ-th sub-group are associated with the same FD component index. Each bit of the Rₙ bits is associated with a layer index. In option 4b, the Mₙ Rₙ bits are further grouped into Rₙ sub-groups each comprising Mₙ bits, and wherein all bits of the rₙ-th sub-group are associated with the same layer index. Each bit of the Mₙ bits is associated with an FD component index.

In certain embodiments, the N sub-groups each comprising MₙRₙ bits are ordered in an increasing order from left to right with respect to a TRP or CSI-RS resource index or a re-mapped TRP or CSI-RS resource index. In option 4a, the Mₙ sub-groups each comprising Rₙ bits are ordered in an increasing order from left to right with respect to the FD index or a re-mapped FD index. The Rₙ bits of each sub-group are ordered in an increasing order from left to right. In option 4b, the Rₙ sub-groups each comprising Mᵥ bits are ordered in an increasing order from left to right. The Mₙ bits of each sub-group are ordered in an increasing order from left to right with respect to the FD index or a re-mapped FD index.

Option 4c+Option 4d:

In certain embodiments, the

$${\sum }_{n = 0}^{N - 1} {M}_{n} {R}_{n}$$

bits in each group are further grouped into M sub-groups, wherein M is the maximum number of selected FD components across N selected TRPs or CSI-RS resources. Each m-th sub-group is associated with an FD component index and comprises

$${\sum }_{n = 0}^{N - 1} {R}_{n}$$

bits. For Mₙ<M, the Rₙ bits associated with the n-th TRP or CSI-RS resource index are present only in the first Mₙ groups. In option 4c, the

$${\sum }_{n = 0}^{N - 1} {R}_{n}$$

bits in each sub-group are further grouped into N sub-groups each comprising Rₙ bits, wherein all bits of the n-th sub-group are associated with the same TRP or CSI-RS resource index. Each bit of the Rₙ bits is associated with a layer index. In option 4d, the

$${\sum }_{n = 0}^{N - 1} {R}_{n}$$

bits in each sub-group are further grouped into R sub-groups, wherein R is the maximum supported rank value across N selected TRPs or CSI-RS resources. For Rₙ<R, the bits associated with the n-th TRP or CSI-RS resource index are present only in the first Rₙ groups. All bits of the r-th subgroup are associated with the same layer index. Each bit in the r-th is associated with a TRP or CSI-RS resource index.

In certain embodiments, the M sub-groups are ordered in an increasing order from left to right with respect to the FD index or a re-mapped FD index. In option 4c, the N sub-groups each comprising Rₙ bits are ordered in an increasing order from left to right with respect to a TRP or CSI-RS resource index or a re-mapped TRP or CSI-RS resource index. The Rₙ bits are ordered in an increasing order from left to right. In option 4d, the R sub-groups are ordered in an increasing order from left to right. The bits in the r-th sub-group are ordered in an increasing order from left to right with respect to a TRP or CSI-RS resource index or a re-mapped TRP or CSI-RS resource index.

Option 4e+Option 4f:

In certain embodiments, the

$${\sum }_{n = 0}^{N - 1} {M}_{n} {R}_{n}$$

bits in each group are further grouped into R sub-groups, wherein R is the maximum supported rank value across N selected TRPs or CSI-RS resources. Each r-th sub-group is associated with a layer index and comprises

$${\sum }_{n = 0}^{N - 1} {M}_{n}$$

bits. For Rₙ<R, the M bits associated with the n-th TRP or CSI-RS resource index are present only in the first Rₙ groups. In option 4e, the

$${\sum }_{n = 0}^{N - 1} {M}_{n}$$

bits in each sub-group are further grouped into N sub-groups each comprising Mₙ bits, wherein all bits of the n-th sub-group are associated with the same TRP or CSI-RS resource index. Each bit of the Mₙ bits is associated with an FD component index. In option 4f, the

$${\sum }_{n = 0}^{N - 1} {M}_{n}$$

bits in each sub-group are further grouped into M sub-groups, wherein M is the maximum number of selected FD components across N selected TRPs or CSI-RS resources. For Mₙ<M, the bit associated with the n-th TRP or CSI-RS resource index is present only in the first Mₙ groups. All bits of the m-th subgroup are associated with the same FD component index. Each bit in the m-th subgroup is associated with a TRP or CSI-RS resource index.

In certain embodiments, the R sub-groups are ordered in an increasing order from left to right. In option 4e, the N sub-groups each comprising

$${\sum }_{n = 0}^{N - 1} {M}_{n}$$

are ordered in an increasing order from left to right with respect to a TRP or CSI-RS resource index or a re-mapped TRP or CSI-RS resource index. The Mᵥ bits are ordered in an increasing order from left to right with respect to the FD index or a re-mapped FD index. In option 4f, the M sub-groups are ordered in an increasing order from left to right with respect to the FD index or a re-mapped FD index. The bits in each sub-group are ordered from left to right with respect to a TRP or CSI-RS resource index or a re-mapped TRP or CSI-RS resource index.

### SD Index Mapping

In certain embodiments, the L SD components are ordered in an increasing order from left to right and are mapped to SD indices l=0, . . . , Lₙ−1 and l=Lₙ, . . . , 2Lₙ−1 associated with a first polarization and a second polarization of the antenna ports, respectively. In some examples, the selected L=4 SD components are {2, 5, 7, 11} and the SD component 2 is mapped to SD index 0 and 4, the SD component 5 is mapped to SD index 1 and 5, the SD component 7 is mapped to SD index 2 and 6, and the SD component 11 is mapped to SD index 3 and 7.

In certain embodiments, the combining coefficients associated with the bits in the bitmap that are associated with the strongest SD component are placed in CSI group 1. The strongest SD component is the SD component that is associated with the strongest coefficient.

In certain embodiments, the SD indices are given by

$${l}_{n}^{′} = mod ( {l}_{n} - {l}_{SCI} , 2 {L}_{n} )$$

or mod(l_{SCI}−l,2Lₙ), where l′ₙ is the re-mapped SD index and l_{SCI} is the SD index associated with the strongest coefficient of the precoding matrix for the n-th selected TRP or CSI-RS resource index.

In certain embodiments, the SD indices

$${l}_{n}^{′} = 0 , … , 2 {L}_{n} - 1$$

are ordered in an increasing order from left to right for the n-th selected TRP or CSI-RS resource index. In some examples, for L=2, the SD component 2 is mapped to SD index 0 and 2 and the SD component 5 is mapped to SD index 1 and 3 and the strongest coefficient is associated with the SD component 2 of the second polarization i.e., l_{SCI}=2. After re-mapping, the new order of SD indices is given by

$${l}_{0}^{′} = \{ 2 , 3 , 0 , 1 \} ,$$

where the re-mapped index 0 is associated with the strongest coefficient i.e., SD component 2 of the second polarization.

In some examples, for L=2, the SD component 2 is mapped to SD index 0 and 2 and the SD component 5 is mapped to SD index 1 and 3 and the strongest coefficient is associated with the SD component 2 of the second polarization i.e., l_{SCI}=2. After re-mapping, the new order is given by

$${l}_{0}^{′} = \{ 2 , 1 , 0 , 3 \} ,$$

where the re-mapped SD index 0 is associated with the strongest coefficient i.e., SD component 2 of the second polarization.

In certain embodiments, the SD index lₙ=l_{SCI} and lₙ=l₀ are re-mapped such the re-mapped SD index is given by

$${l}_{n}^{′} = 0 and {l}_{n}^{′} = {l}_{0} ,$$

respectively and the remaining SD indices are ordered based on the natural ordering.

In some examples, for L=2, the SD component 2 is mapped to SD index 0 and 2 and the SD component 5 is mapped to SD index 1 and 3 and the strongest coefficient is associated with the SD component 2 of the second polarization i.e., l_{SCI}=2. After re-mapping the SD indices lₙ=2 and lₙ=0, the re-mapping order is given by {2, 1, 0, 3}, where the re-mapped SD index 0 is associated with the strongest coefficient i.e., SD component 2 of the second polarization and re-mapped index 2 is associated with the SD component 2 of the first polarization of the antenna or CSI-RS ports.

In certain embodiments, the permutation is performed only on a subset of layers or on a subset of TRPs or CSI-RS resources. In some examples, the permutation on SD and/or FD indices is performed per layer and per TRP. In some examples, the permutation on SD and/or FD indices is performed only for the first layer and per TRP. In some examples, the permutation on SD and/or FD indices is performed only for the first layer and the strongest TRP, wherein the strongest TRP is the TRP associated with the strongest coefficient. In some examples, the permutation on SD and/or FD indices is performed only for all layers and the strongest TRP, wherein the strongest TRP is the TRP associated with the strongest coefficient.

In certain embodiments, the M FD components are ordered in an increasing order from left to right and are mapped to FD indices mₙ=0, . . . , Mₙ−1. In some examples, the selected M=4 SD components are {2, 3, 6, 7} and the FD component 2 is mapped to FD index 0, the FD component 3 is mapped to FD index 1, the FD component 6 is mapped to FD index 2, and the FD component 7 is mapped to FD index 3.

### FD Index Mapping

In certain embodiments, the combining coefficients associated with the bits in the bitmap that are associated with the strongest FD component are placed in CSI group 1. The strongest SD component is the FD component that is associated with the strongest coefficient.

In certain embodiments, the FD indices are given by

$${m}_{n}^{′} = mod ( {m}_{n} - {m}_{SCI} , {M}_{n} )$$

or mod(m_{SCI}−m,Mₙ), where

$${m}_{n}^{′}$$

is the re-mapped FD index and m_{SCI} is the FD index associated with the strongest coefficient of the precoding matrix for the n-th selected TRP or CSI-RS resource index.

In certain embodiment, the FD indices

$${m}_{n}^{′} = 0 , … , {M}_{n} - 1$$

are ordered in an increasing order from left to right for the n-th selected TRP or CSI-RS resource index. In some examples, for M=2, the FD component 2 is mapped to FD index 0 and the FD component 3 is mapped to FD index 1 and the strongest coefficient is associated with the FD component 3 i.e., m_{SCI}=1. After re-mapping, the new order of FD indices is given by

$${m}_{0}^{′} = \{ 1 , 0 \} ,$$

where the re-mapped index 0 is associated with the strongest coefficient i.e., FD component 3.

In some examples, for M=2, the FD component 2 is mapped to FD index 0 and the FD component 3 is mapped to FD index 1 and the strongest coefficient is associated with the FD component 3 i.e., m_{SCI}=1. After re-mapping, the new order is given by

$${m}_{0}^{′} = \{ 1 , 0 \} ,$$

where the re-mapped FD index 0 is associated with the strongest coefficient i.e., FD component 3.

In certain embodiments, the FD index mₙ=m_{SCI} and mₙ=m₀ are re-mapped such the permuted FD index is given by

$${m}_{n}^{′} = 0 and {m}_{n}^{′} = {m}_{0} ,$$

respectively and the remaining FD indices are ordered based on the natural ordering.

### TRP or CSI-RS Resource Index Mapping

In certain embodiments, the N selected TRP or CSI-RS resources are ordered in an increasing order from left to right and are mapped to TRP or CSI-RS resources n=0, . . . , N−1. In some examples, for N=4 TRP or CSI-RS resources, TRP 0 is mapped to TRP or CSI-resource index 0, TRP 1 is mapped to TRP or CSI-resource 1, TRP 2 is mapped to TRP or CSI-resource index 2, and TRP 3 is mapped to TRP or CSI-resource index 3.

In some examples, the numbering of the TRPs is based on the numbering of the configured N TRPs or CSI-RS resources.

In some examples, the numbering of the TRPs is based on the numbering of the configured N TRPs or CSI-RS resources indicated in the CSI report configuration.

In certain embodiments, the TRP or CSI-RS resource indices are given by n′=mod(n−n_{SCI}, N) or mod(n_{SCI}−n, N), where n′ is the re-mapped SD index and n_{SCI} is the TRP index associated with the strongest coefficient of the precoding matrix of the n-th selected TRP or CSI-RS resource index.

In certain embodiments, the TRP indices n′=0, . . . , N−1 are ordered in an increasing order from left to right for the n-th selected TRP or CSI-RS resource index. In some examples, for N=2, the TRP or CSI-resource 0 is mapped to TRP or CSI-resource 0 and the TRP or CSI-resource 1 is mapped to TRP or CSI-resource 1 and the strongest coefficient is associated with the TRP or CSI-resource 1 i.e., n_{SCI}=1. After re-mapping, the new order of TRP or CSI-resources is given by n′={1, 0}, where the re-mapped index 0 is associated with the strongest TRP or CSI-resource i.e., TRP or CSI-resource 1.

In certain embodiments, the TRP or CSI-Resource index n=n_{SCI} and n=0 are re-mapped such the re-mapped TRP or CSI-resource index is given by n′=0 and n′=n_{SCI}, respectively.

In certain embodiments, the N selected TRPs are one-to-one mapped to the TRP index n, n={0, . . . , N_{TRP}−1}, wherein the TRPs are ordered in a decreasing order from left to right with respect to a sum power constraint of the non-zero combining coefficients.

In some examples, for N=4, and the ordering of the TRPs with respect to the power in decreasing order is {1, 3, 0, 2}, TRP 1 is mapped to TRP index 0, TRP 3 is mapped to TRP index 1, TRP 0 is mapped to TRP index 2, and TRP 2 is mapped to TRP index 3.

In certain embodiments, the N selected TRPs are one-to-one mapped to the TRP index n, n={0, . . . , N−1}, wherein the TRP associated with the strongest coefficient is associated with TRP index 0.

In certain embodiments, the wireless device is configured to report the ordering of the N selected TRPs or CSI-RS resources in the CSI report, wherein the ordering of the TRPs is based on an increasing order of power or decreasing order of power.

### Partitioning of Bits in Bitmap in CSI Report

In certain embodiments, the bits of the bitmap are segmented into two segments, wherein the first segment comprises the first

$${\sum }_{n = 0}^{N - 1} 2 {L}_{n} {M}_{n} {R}_{n} - ⌊ \frac{K}{2} ⌋$$

bits and assigned to CSI group 1 and the second segment comprises the remaining

$$⌊ \frac{K}{2} ⌋$$

bits and assigned to CSI group 2. Here, K denotes the number of non-zero combining coefficients of the precoder matrix.

### Partitioning of Number of Non-Zero Coefficients in CSI Report

In certain embodiments, the amplitude values, or the differential amplitude values (e.g., in case that each amplitude coefficient of a non-zero coefficient is represented by product of a reference or common amplitude coefficient and a differential amplitude coefficient) of the K or less than K non-zero combining coefficients in the CSI report are quantized with A bits common amplitude and B bits of differential amplitude.

In certain embodiments, the total number of bits associated with the phase and amplitude (or differential amplitude values) of the K or less than K non-zero combining coefficients are segmented into two segments, wherein the first segment is assigned to CSI group 1, and the second segment is assigned to CSI group 2.

In certain embodiments, the phase values of K or less than K non-zero combining coefficient in the CSI report are quantized with using C bits, respectively.

In certain embodiments, the total number of bits used for quantizing the differential amplitude of the K or less than K non-zero combining coefficients is segmented into two or more segments and assigned to two or more CSI groups.

In certain embodiments, the total number of bits associated with the differential amplitude of the K or less than K non-zero combining coefficients is segmented into two segments, wherein the first segment comprises a maximum of

$$( ⌈ \frac{K}{2} ⌉ - RI ) \cdot B$$

bits and is assigned to CSI group 1, and the second segment comprises a maximum of

$$⌊ \frac{K}{2} ⌋ \cdot B$$

bits and is assigned to CSI group 2. In certain embodiments, the total number of bits associated with the phase of the K or less than K non-zero combining coefficients is segmented into two segments, wherein the first segment comprises a maximum of

$$( ⌈ \frac{K}{2} ⌉ - RI ) \cdot C$$

bits and is assigned to CSI group 1, and the second segment comprises a maximum of

$$⌊ \frac{K}{2} ⌋ \cdot C$$

bits and is assigned to SCI group 2.

In certain embodiments, the total number of bits associated with the differential amplitude of the K or less than K non-zero combining coefficients is segmented into two segments, wherein the first segment comprises a maximum of

$$max ( 0 , ( ⌈ \frac{K}{2} ⌉ - RI ) ) \cdot B$$

bits and is assigned to CSI group 1, and the second segment comprises a maximum of

$$min ( K - RI , ⌊ \frac{K}{2} ⌋ ) \cdot B$$

bits and is assigned to CSI group 2.

In certain embodiments, the total number of bits associated with the phase of the K or less than K non-zero combining coefficients is segmented into two segments, wherein the first segment comprises a maximum of

$$max ( 0 , ( ⌈ \frac{K}{2} ⌉ - RI ) ) \cdot C$$

bits and is assigned to CSI group 1, and the second segment comprises a maximum of

$$min ( K - RI , ⌊ \frac{K}{2} ⌋ ) \cdot C$$

bits and is assigned to CSI group 2.

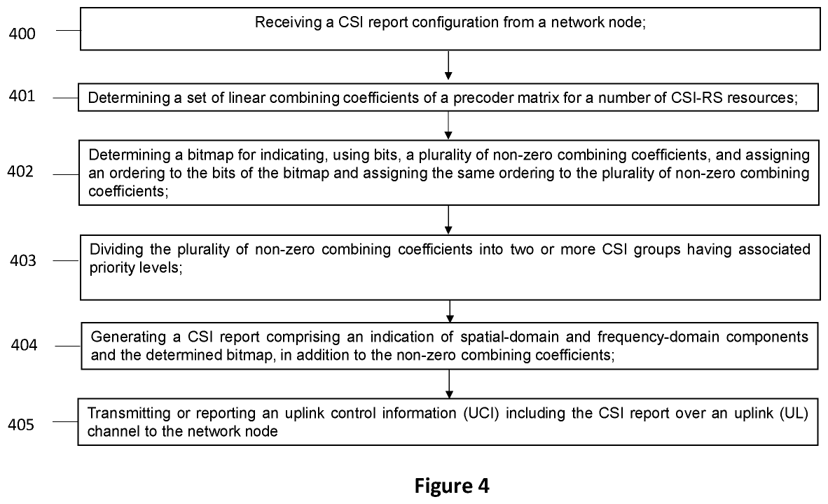

Referring to FIG. 4, there is illustrated a method performed by a wireless device according to some of the previously described embodiments. The method is performed by the wireless device (or UE) for generating and reporting or transmitting a CS, report, the CSI report including a precoder matrix, the precoder matrix being expressed as a linear combination of spatial-domain component(s) and frequency-domain component(s), the method comprising:
receiving (400) a CSI report configuration from a network node;
determining (401), based on the received CSI report configuration, a set of linear combining coefficients of a precoder matrix for a number of CSI-RS resources; wherein the set of linear combining coefficients comprises a plurality of non-zero combining coefficients, and wherein the CSI-RS resources are indicated in the CSI report configuration;
determining (402) a bitmap for indicating, using bits or by means of bits, a plurality of non-zero combining coefficients from the set of linear combining coefficients, and assigning an ordering to the bits of the bitmap and assigning the same ordering to the plurality of non-zero combining coefficients, to be reported together with the bitmap, to the network node in a CSI report;
dividing (403) the plurality of non-zero combining coefficients into two or more CSI groups having associated priority levels;
generating (404) a CSI report comprising an indication of the spatial-domain and frequency-domain components and the determined bitmap, in addition to the non-zero combining coefficients, wherein the CSI report comprises a CSI part 1 and a CSI part 2, wherein CSI part 1 has a fixed payload size and comprises information indicating the size of the payload of CSI part 2, and wherein CSI part 2 includes the non-zero combining coefficients of at least one of the two or more CSI groups; and
transmitting (405) or reporting an uplink control information (UCI) including the CSI report over an uplink, UL, channel to the network node.

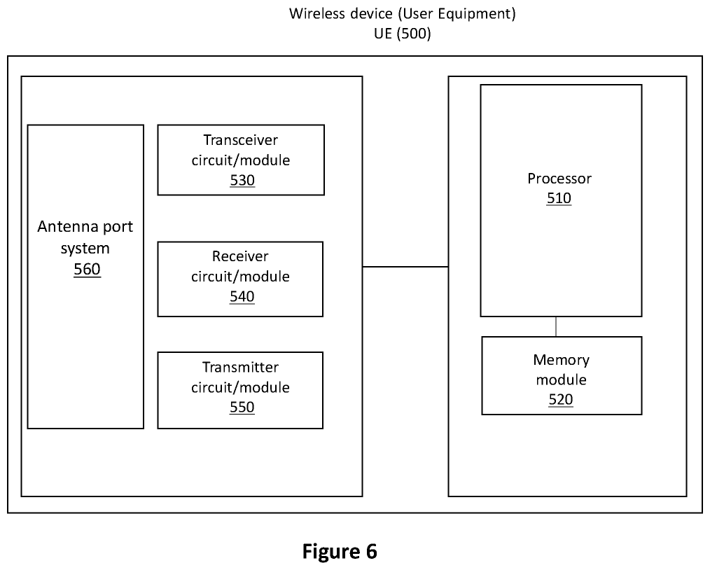

In order to perform the previously described process or method steps performed by the wireless device or UE, there is also provided a wireless device. FIG. 6 illustrates a simplified block diagram depicting a wireless device or UE 500. The wireless device 500 comprises a processor 510 or processing circuit or a processing module or a processor means 510; a receiver circuit or receiver module 540; a transmitter circuit or transmitter module 550; a memory module 520, a transceiver circuit or transceiver module 530 which may include the transmitter circuit 550 and the receiver circuit 540. The wireless device 500 further comprises an antenna system 560 which includes antenna circuitry for transmitting and receiving signals to/from at least the network node or other wireless device(s). The antenna system employs beamforming as previously described.

The wireless device 500 may belong to any radio access technology including 4G or LTE, LTE-A, 5G, advanced 5G or a combination thereof that support beamforming technology. The wireless device comprising the processor and the memory contains instructions executable by the processor, whereby the wireless device 500 is operative or is configured to perform any one of the embodiments related to the wireless device as previously described.

The processing module/circuit 510 includes a processor, microprocessor, an application specific integrated circuit (ASIC), field programmable gate array (FPGA), or the like, and may be referred to as the “processor.” The processor 510 controls the operation of the wireless device and its components. Memory (circuit or module) 520 includes a random-access memory (RAM), a read only memory (ROM), and/or another type of memory to store data and instructions that may be used by processor 510. In general, it will be understood that the wireless device 500 in one or more embodiments includes fixed or programmed circuitry that is configured to carry out the operations in any of the embodiments disclosed herein.

In at least one such example, the processor 510 includes a microprocessor, microcontroller, DSP, ASIC, FPGA, or other processing circuitry that is configured to execute computer program instructions from a computer program stored in a non-transitory computer-readable medium that is in or is accessible to the processing circuitry. Here, “non-transitory” does not necessarily mean permanent or unchanging storage, and may include storage in working or volatile memory, but the term does connote storage of at least some persistence. The execution of the program instructions specially adapts or configures the processing circuitry to carry out the operations disclosed in this disclosure relating to the wireless device. Further, it will be appreciated that the wireless device 500 may comprise additional components.

The wireless device 500 by means of processor 510 executes instructions contained in the memory 520 whereby the wireless device is operative to perform any one of the previously described embodiments related to the actions performed by the wireless device, some of which are presented in appended claims.

There is also provided a computer program comprising instructions which when executed by the processor 510 of the wireless device cause the processor 510 to carry out the method according to any one of the previously described embodiments.

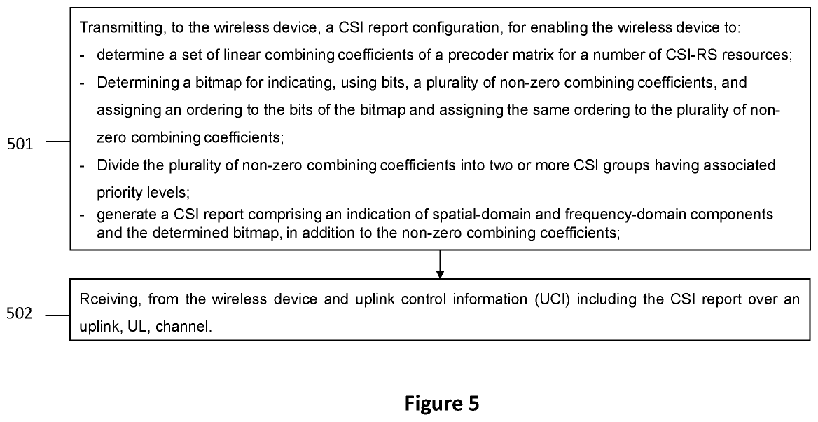

Referring to FIG. 5, there is illustrated a method performed by a network node 600 according to some of the previously described embodiments. The method performed by the network device 600 is used for receiving a CSI report from a wireless device 500, the CSI report indicating a precoder matrix, the precoder matrix being expressed as a linear combination of spatial-domain, SD, component(s) and frequency-domain, FD, component(s), and a set of linear combination coefficients for combining the spatial- and frequency-domain components. FIG. 5 illustrates the main method steps, which comprise:
transmitting (501), to the wireless device, a CSI report configuration; for enabling the wireless device to:
   determine based on the received CSI report configuration, a set of linear combining coefficients of a precoder matrix for a number of CSI-Reference Signal, CSI-RS, resources; wherein the set of linear combining coefficients comprises a plurality of non-zero combining coefficients, and wherein the CSI-RS resources are indicated in the CSI report configuration;
   determine a bitmap for indicating, using bits or by means of bits, a plurality of non-zero combining coefficients from the set of linear combining coefficients;
   assign an ordering to the bits of the bitmap and assigning the same ordering to the plurality of non-zero combining coefficients, to be reported together with the bitmap, to the network node in a CSI report;
   divide the plurality of non-zero combining coefficients into two or more CSI groups having associated priority levels;
   generate a CSI report, for transmission to the network node comprising an indication of the spatial-domain and frequency-domain components and the determined bitmap, in addition to the non-zero combining coefficients, wherein the CSI report comprises a CSI part 1 and a CSI part 2, wherein CSI part 1 has a fixed payload size and comprises information indicating the size of the payload of CSI part 2, and wherein CSI part 2 includes the non-zero combining coefficients of at least one of the two or more CSI groups; and
receiving (502), from the wireless device and uplink control information (UCI) including the CSI report over an uplink, UL, channel.

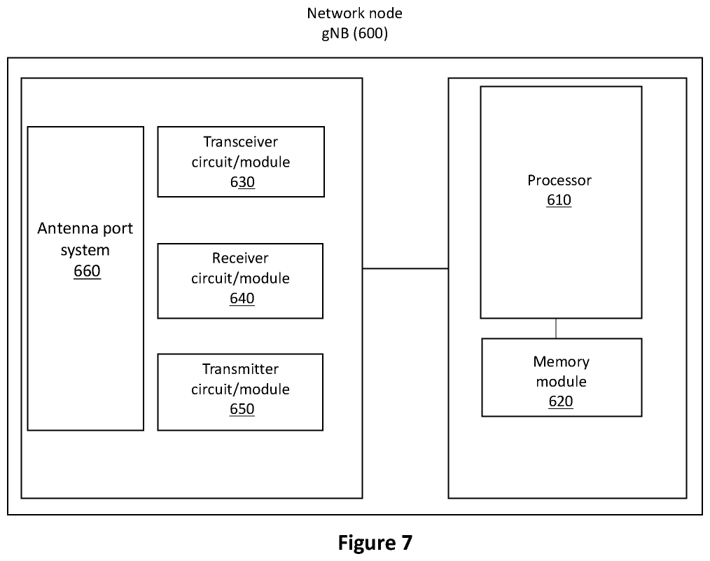

In order to perform the previously described process or method steps performed by the network node there is also provided a network node. FIG. 7 illustrates a block diagram depicting a network node 600. The network node 600 comprises a processor 610 or processing circuit or a processing module or a processor means 610; a receiver circuit or receiver module 640; a transmitter circuit or transmitter module 650; a memory module 620, a transceiver circuit or transceiver module 630 which may include the transmitter circuit 650 and the receiver circuit 640. The network node 600 further comprises an antenna system 660 which includes antenna circuitry for transmitting and receiving signals to/from at least the wireless device. The antenna system employs beamforming as previously described.

The network node 600 may belong to any radio access technology including 4G or LTE, LTE-A, 5G, advanced 5G or a combination thereof that support beamforming technology. The network device comprising the processor and the memory contains instructions executable by the processor, whereby the network node 600 is operative or is configured to perform any one of the embodiments related to the network node 600 as previously described.

The processing module/circuit 610 includes a processor, microprocessor, an application specific integrated circuit (ASIC), field programmable gate array (FPGA), or the like, and may be referred to as the “processor.” The processor 610 controls the operation of the network node and its components. Memory (circuit or module) 620 includes a random-access memory (RAM), a read only memory (ROM), and/or another type of memory to store data and instructions that may be used by processor 610. In general, it will be understood that the network node in one or more embodiments includes fixed or programmed circuitry that is configured to carry out the operations in any of the embodiments disclosed herein.

In at least one such example, the processor 610 includes a microprocessor, microcontroller, DSP, ASIC, FPGA, or other processing circuitry that is configured to execute computer program instructions from a computer program stored in a non-transitory computer-readable medium that is in or is accessible to the processing circuitry. Here, “non-transitory” does not necessarily mean permanent or unchanging storage, and may include storage in working or volatile memory, but the term does connote storage of at least some persistence. The execution of the program instructions specially adapts or configures the processing circuitry to carry out the operations disclosed in this disclosure relating to the wireless device. Further, it will be appreciated that the wireless device 600 may comprise additional components. The network node 600 may also be viewed as a Transmitter and Receiver Point (TRP).

The network node 600 by means of processor 610 executes instructions contained in the memory 620 whereby the network node 600 is operative to perform any one of the previously described embodiments related to the actions performed by the network node, some of which are presented in appended claim 2.

There is also provided a computer program comprising instructions which when executed by the processor 610 of the network node cause the processor 610 to carry out the method according to any one of claim 2.

Several advantages of the described embodiments in this disclosure are achieved as previously described and which include significantly reducing the feedback overhead and the computational complexity at the wireless device for codebook-based CSI reporting. Another advantage is to reduce latency in the CSI reporting.

Reference throughout this specification to “an example” or “exemplary” means that a particular feature, structure, or characteristic described in connection with the example is included in at least one embodiment of the present technology. Thus, appearances of the phrases “in an example” or the word “exemplary” in various places throughout this specification are not necessarily all referring to the same embodiment.

Throughout this disclosure, the word “comprise” or “comprising” has been used in a non-limiting sense, i.e. meaning “consist at least of”. Although specific terms may be employed herein, they are used in a generic and descriptive sense only and not for purposes of limitation. The embodiments herein may be applied in any wireless systems including LTE or 4G, LTE-A (or LTE-Advanced), 5G, advanced 5G, WIMAX, WiFi, satellite communications, TV broadcasting etc.

1. A method performed by a wireless device for generating and reporting or transmitting a channel state information, CSI, report in a wireless communication system, the CSI report including a precoder matrix, the precoder matrix being expressed as a linear combination of spatial-domain component(s) and frequency-domain component(s), the method comprising:
receiving a CSI report configuration from a network node;
determining, based on the received CSI report configuration, a set of linear combining coefficients of a precoder matrix for a number of CSI-Reference Signal, CSI-RS, resources; wherein the set of linear combining coefficients comprises a plurality of non-zero combining coefficients, and wherein the CSI-RS resources are indicated in the CSI report configuration;
determining a bitmap for indicating, using bits or by means of bits, a plurality of non-zero combining coefficients from the set of linear combining coefficients, and assigning an ordering to the bits of the bitmap and assigning the same ordering to the plurality of non-zero combining coefficients, to be reported together with the bitmap, to the network node in a CSI report,
dividing the plurality of non-zero combining coefficients into two or more CSI groups having associated priority levels;
generating a CSI report comprising an indication of the spatial-domain and frequency-domain components and the determined bitmap, in addition to the non-zero combining coefficients, wherein the CSI report comprises a CSI part 1 and a CSI part 2, wherein CSI part 1 has a fixed payload size and comprises information indicating the size of the payload of CSI part 2, and wherein CSI part 2 includes the non-zero combining coefficients of at least one of the two or more CSI groups; and
transmitting or reporting an uplink control information (UCI) including the CSI report over an uplink, UL, channel to the network node;
wherein the bitmap comprises
$${\sum }_{n = 0}^{N - 1} 2 {L}_{n} {M}_{n} {R}_{n}$$
bit fields, wherein each bit is associated with a transmission/reception point, TRP, index (n), a spatial domain, SD, component index (lₙ), a frequency domain, FD, component index (mₙ), and a rank index (rₙ), wherein lₙ=0, . . . , 2Lₙ−1, mₙ=0, . . . , Mₙ−1, and rₙ=0, . . . , Rₙ−1, and Lₙ, Mᵥ, and Rₙ denote the CSI-RS resource specific number of SD components, CSI-RS resource specific number of FD components, and CSI-RS resource specific supported rank value or number of layers for the n-th CSI-RS resource, respectively, wherein N is the number of selected CSI-RS resources.

2. The method according to claim 1, wherein the
$${\sum }_{n = 0}^{N - 1} 2 {L}_{n} {M}_{n} {R}_{n}$$
bit fields are grouped into M groups, wherein M is the maximum number of selected FD components across N selected TRPs or CSI-RS resources, and wherein each group is associated with a m-th FD index and comprises
$${\sum }_{n = 0}^{N - 1} 2 {L}_{n} {R}_{n}$$
bits.

3. The method according to claim 2, wherein the M sub-groups are ordered in an increasing order from left to right with respect to a re-mapped FD index.

4. The method according to claim 2, wherein the
$${\sum }_{n = 0}^{N - 1} 2 {L}_{n} {R}_{n}$$
bits in each group are further grouped into N sub-groups each comprising 2LₙRₙ bits, wherein the n-th sub-group is associated with a TRP or CSI-RS resource index, and wherein the N sub-groups are ordered in an increasing order from left to right with respect to a TRP or CSI-RS resource index.

5. The method according to claim 4, wherein the 2LₙRₙ bits are further grouped into 2Lₙ sub-groups each comprising Rₙ bits, and wherein all bits of the lₙ-th sub-group are associated with the same SD component index, and wherein each bit of the Rₙ bits is associated with a layer index.

6. The method according to claim 5, wherein the 2Lₙ sub-groups each comprising Rₙ bits are ordered in an increasing order from left to right with respect to the SD index, and wherein the Rₙ bits of each sub-group are ordered in an increasing order from left to right.

7. The method according to claim 1, wherein for RI>1, the maximum of non-zero combining coefficients summed across all layers and across all N selected CSI-RS resources or transmission/reception points, TRPs, is given by 2K₀, where RI is a rank of the precoder matrix.

8. The method according to claim 1, wherein the bits of the bitmap are segmented into two segments, wherein the first segment comprises the first
$${\sum }_{n = 0}^{N - 1} 2 {L}_{n} {M}_{n} {R}_{n} - ⌊ \frac{K}{2} ⌋$$
bits and assigned to CSI group 1 and the second segment comprises the remaining
$$⌊ \frac{K}{2} ⌋$$
bits and assigned to CSI group 2, and wherein K denotes the number of non-zero combining coefficients of the precoder matrix.

9. The method according to claim 1, wherein each amplitude coefficient of a non-zero coefficient is represented by product of a reference or common amplitude coefficient and a differential amplitude coefficient, and wherein the differential amplitude of the K or less than K non-zero combining coefficients in the CSI report are quantized with A bits common amplitude and B bits of differential amplitude, wherein K denotes the number of non-zero combining coefficients of the precoder matrix.

10. The method according to claim 9, wherein the total number of bits associated with the differential amplitude of the K or less than K non-zero combining coefficients is segmented into two segments, wherein the first segment comprises a maximum of
$$max ( 0 , ( ⌈ \frac{K}{2} ⌉ - RI ) ) \cdot B$$
bits and is assigned to CSI group 1, and the second segment comprises a maximum of
$$min ( K - RI , ⌊ \frac{K}{2} ⌋ ) \cdot B$$
bits and is assigned to CSI group 2, wherein RI is a rank of the precoder matrix.

11. The method according to claim 1, the phase values of K or less than K non-zero combining coefficient in the CSI report are quantized with using C bits, and wherein the total number of bits associated with the phase of the K or less than K non-zero combining coefficients is segmented into two segments, wherein the first segment comprises a maximum of
$$max ( 0 , ( ⌈ \frac{K}{2} ⌉ - RI ) ) \cdot C$$
bits and is assigned to CSI group 1, and the second segment comprises a maximum of
$$min ( K - RI , ⌊ \frac{K}{2} ⌋ ) \cdot C$$
bits and is assigned to CSI group 2, wherein RI is a rank of the precoder matrix, and wherein K denotes the number of non-zero combining coefficients of the precoder matrix.

12. The method of any one of the preceding claims, wherein the ordering of the amplitude and phase information of the combining coefficients follows the ordering of the bits or bit fields in the bitmap of the CSI report.

13. A method performed by a network node for receiving, from a wireless device, a channel state information, CSI, report in a wireless communication system, the CSI report indicating a precoder matrix, the precoder matrix being expressed as a linear combination of spatial-domain component(s) and frequency-domain component(s), the method comprising:
transmitting, to the wireless device, a CSI report configuration; for enabling the wireless device to:
determine based on the received CSI report configuration, a set of linear combining coefficients of a precoder matrix for a number of CSI-Reference Signal, CSI-RS, resources; wherein the set of linear combining coefficients comprises a plurality of non-zero combining coefficients, and wherein the CSI-RS resources are indicated in the CSI report configuration;
determine a bitmap for indicating, using bits or by means of bits, a plurality of non-zero combining coefficients from the set of linear combining coefficients;
assign an ordering to the bits of the bitmap and assigning the same ordering to the plurality of non-zero combining coefficients, to be reported together with the bitmap, to the network node in a CSI report,
divide the plurality of non-zero combining coefficients into two or more CSI groups having associated priority levels;
generate a CSI report, for transmission to the network node comprising an indication of the spatial-domain and frequency-domain components and the determined bitmap, in addition to the non-zero combining coefficients, wherein the CSI report comprises a CSI part 1 and a CSI part 2, wherein CSI part 1 has a fixed payload size and comprises information indicating the size of the payload of CSI part 2, and wherein CSI part 2 includes the non-zero combining coefficients of at least one of the two or more CSI groups; and
receiving, from the wireless device and uplink control information (UCI) including the CSI report over an uplink, UL, channel;
wherein the bitmap comprises
$${\sum }_{n = 0}^{N - 1} 2 {L}_{n} {M}_{n} {R}_{n}$$
bit fields, wherein each bit is associated with a transmission/reception point, TRP, index (n), a spatial domain, SD, component index (lₙ), a frequency domain, FD, component index (mₙ), and a rank index (rₙ), wherein lₙ=0, . . . , 2Lₙ−1, mₙ=0, . . . , Mₙ−1, and lₙ=0, . . . , Rₙ−1, and Lₙ, Mₙ, and Rₙ denote the CSI-RS resource specific number of SD components, CSI-RS resource specific number of FD components, and CSI-RS resource specific supported rank value or number of layers for the n-th CSI-RS resource, respectively, wherein N is the number of selected CSI-RS resources.

14. A network node comprising a processor and a memory containing instructions executable by said processor, whereby the network node is operative to perform claim 13.

15. A wireless device comprising a processor and a memory containing instructions executable by said processor, whereby the wireless device is operative to perform claim 1.
